(19) United States
(12) Patent Application Publication
(10) Pub. No.: US 2026/0349711 A1
(43) Pub. Date: Nov. 5, 2026

(54) MODIFICATION OF CONTAINER IMAGES USING CACHE DATA

(71) Applicant: International Business Machines Corporation, Armonk, NY (US)

(72) Inventors: Yu Zui You, Ningbo (CN); Heng Wang, Changping District (CN); Xiao Ling Chen, Changping District (CN); Qi Li, BEIJING (CN)

(21) Appl. No.: 19/197,361

(22) Filed: May 2, 2025

(51) Int. Cl. G06F 8/71; G06F 8/61

(52) U.S. Cl. CPC G06F 8/71; G06F 8/63

(57) ABSTRACT

Modification of container images is provided and includes receiving a first set of instructions associated with a first set of dependency files of an application. The first set of instructions is associated with a regeneration of a specific layer of a container image. A second set of instructions associated with the specific layer is obtained from cache data. The second set of instructions is associated with a second set of dependency files. A first parameter associated with each dependency file of the first set of dependency files is compared with a second parameter associated with a corresponding dependency file of the second set of dependency files. Based on the comparison, at least one specific instruction is generated, and a specific portion is generated based on the generated at least one specific instruction. Based on the generated specific portion, a modified container image is generated and outputted.

### BACKGROUND

The disclosure relates to containerization, and more particularly, to container images in container platforms.

In recent years, there has been a notable shift from traditional monolithic applications, which typically operate on virtual or physical servers, to microservices architectures that leverage containers. The evolution is driven by the need for enhanced flexibility, scalability, and efficiency in software development processes. Containerization technologies have become critical tools in the transformation, enabling developers to package applications and the dependencies into isolated environments known as container images.

A container image is a lightweight, standalone, and executable package that includes everything needed to run a piece of software, including the application code, runtime, libraries, environment variables, and configuration files. Container images are revolutionizing the way software is written, deployed, and operated. As a result, organizations can deploy new features and fixes more rapidly, significantly improving the time-to-market. The application of containerization technologies extends beyond mere software development; the containerization technologies also enhance operational efficiency and resource utilization. By encapsulating applications in containers, the organizations can achieve greater consistency across different environments, from development to production.

### SUMMARY

In various embodiments of the disclosure, a computer-implemented method for modification of container images using cache data is described. The computer-implemented method includes receiving, by a computer, a first set of instructions including a first directory path associated with a first set of dependency files of an application. The first set of instructions is associated with a regeneration of a specific layer of a container image. The container image is associated with the application. The regeneration of the specific layer is based on the first set of dependency files. The computer-implemented method further includes obtaining, by the computer, a second set of instructions associated with the specific layer. The second set of instructions includes a second directory path associated with a second set of dependency files of the application. The second set of instructions is obtained from the cache data. The cache data is associated with the container image. The computer-implemented method further includes comparing, by the computer, a first parameter associated with each dependency file of the first set of dependency files with a second parameter associated with a corresponding dependency file of the second set of dependency files. The computer-implemented method further includes generating, by the computer, at least one specific instruction for the specific layer based on the comparing of the first parameter with the second parameter. The at least one specific instruction is indicative of a modification of at least one dependency file of the second set of dependency files. The computer-implemented method further includes generating, by the computer, a specific portion of the specific layer based on the generated at least one specific instruction. The computer-implemented method further includes generating, by the computer, a modified container image of the application based on the generated specific portion. The computer-implemented method further includes outputting, by the computer, the modified container image.

In various embodiments of the disclosure, a computer system for modification of container images using cache data is described. The computer system includes a processor set, one or more computer-readable storage media, and program instructions stored on the one or more computer-readable storage media. The program instructions are executable by the processor set and cause the processor set to receive a first set of instructions including a first directory path associated with a first set of dependency files of an application. The first set of instructions is associated with a regeneration of a specific layer of a container image. The container image is associated with the application. The regeneration of the specific layer is based on the first set of dependency files. The program instructions further cause the processor set to obtain a second set of instructions associated with the specific layer. The second set of instructions includes a second directory path associated with a second set of dependency files of the application. The second set of instructions is obtained from the cache data. The cache data is associated with the container image. The cache data is associated with the container image. The program instructions further cause the processor set to compare a first parameter associated with each dependency file of the first set of dependency files with a second parameter associated with a corresponding dependency file of the second set of dependency files. The program instructions further cause the processor set to generate at least one specific instruction for the specific layer based on the comparison of the first parameter with the second parameter. The at least one specific instruction is indicative of a modification of at least one dependency file of the second set of dependency files. The program instructions further cause the processor set to generate a specific portion of the specific layer based on the generated at least one specific instruction. The program instructions further cause the processor set to generate a modified container image of the application based on the generated specific portion. The program instructions further cause the processor set to a control a deployment of a container to host the application. The control of the deployment of the container is based on the generated modified container image.

In various embodiments of the disclosure, a computer-program product for modification of container images using cache data is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF DRAWINGS

The following description will provide details of preferred embodiments with reference to the following figures, wherein:

FIG. 1 is a diagram that illustrates a computing environment for modification of container images using cache data, in accordance with an embodiment of the disclosure;

FIG. 2 is a diagram that illustrates an environment for modification of container images using cache data, in accordance with an embodiment of the disclosure;

FIG. 3A is a diagram that illustrates exemplary operations for the generation of a specific portion of a specific layer for modification of container images using cache data, in accordance with an embodiment of the disclosure;

FIG. 3B is a diagram that illustrates exemplary operations for the generation of a modified container image using cache data, in accordance with an embodiment of the disclosure;

FIG. 4 is a diagram that illustrates exemplary operations for the deployment of a container to host an application using the modified container image, in accordance with an embodiment of the disclosure;

FIG. 5 is a diagram that illustrates an exemplary pictorial representation of a scenario for the generation of a modified container image using cache data, in accordance with an embodiment of the disclosure;

FIG. 6 is a diagram that illustrates an exemplary pictorial representation of the modified metadata associated with the generated modified container image, in accordance with an embodiment of the disclosure;

FIG. 7A is a diagram that illustrates an exemplary first user interface for modification of container images using cache data, in accordance with an embodiment of the disclosure;

FIG. 7B is a diagram that illustrates an exemplary second user interface for modification of container images using cache data, in accordance with an embodiment of the disclosure;

FIG. 8 is a diagram that illustrates a flowchart of an exemplary method for the generation of a modified container image using cache data, in accordance with an embodiment of the disclosure; and

FIG. 9 is a diagram that illustrates a flowchart of an exemplary method for the deployment of a container to host an application using the modified container image, in accordance with an embodiment of the disclosure.

### DETAILED DESCRIPTION

Containerization is a technology that has revolutionized software development and deployment of containerized applications in recent years. The demand for scalability, fast deployment, and effective resource allocation has brought the growth of the software development towards containerization as organizations have started embracing cloud-native architecture. Containers encapsulate applications and dependencies of the applications, allowing the applications to run consistently across different environments such as development, testing, deployment, and production. The consistency of the applications is vital for modern development practices, enabling teams to build, test, and deploy the applications with ease and confidence, knowing that the applications will behave the same way in production as the applications do in development.

A container image is a lightweight, standalone, and executable package that includes everything needed to run a piece of software, including the application code, runtime, libraries, environment variables, and configuration files. Container images are revolutionizing the way software is written, deployed, and operated. As a result, the organizations can deploy new features and fixes more rapidly, significantly improving the time-to-market. The application of containerization technologies extends beyond mere software development, the containerization technologies also enhance operational efficiency and resource utilization. By encapsulating applications in containers, organizations can achieve greater consistency across different environments, from development to production.

The container image is a combination of a set of layers that stores the application code, runtime, libraries, environment variables, and configuration files (dependencies). These container images have a wide range of applications across various sectors, particularly in software development and deployment. In the field of software development, the container images allow teams to create consistent environments that mirror production settings, reducing the risk of discrepancies and ensuring that applications function as intended. The consistency provided by the container images accelerates the development lifecycle, enabling faster iterations and more reliable releases.

Additionally, the container images enables continuous integration and delivery (CI/CD) practices, allowing organizations to automate testing and deployment processes, thereby improving overall efficiency. In the field of cloud computing, container images enable organizations to manage resource utilization and scale applications dynamically. By deploying containerized applications in cloud environments, businesses can take advantage of on-demand resources, reducing operational costs and enhancing performance.

Despite the advantages of container images, several challenges persist in the current scenario of the generation of these container images, particularly concerning the efficiency of container image build process. One of the primary issues is the inefficiency of the caching mechanism utilized during the container image build process. For instance, when a minor modification is made to a dependency file in an application's requirements file, the existing caching mechanism fails to identify which dependency files have already been cached and can be reused. Due to the failure of the caching mechanism to identify the dependency files that can be reused, the entire installation process is re-triggered, leading to unnecessary consumption of processing time and computational resources for the generation of container images. In large-scale projects with numerous dependency files, the inefficiency of the caching mechanism can result in substantial delays, ultimately hindering the overall development timeline.

Also, a critical challenge lies in the lack of dependency file change detection within the caching mechanism. The traditional methods for the generation of container images operate on a layer-based approach, meaning that any alteration or change in dockerfile leads to a rebuilding or regeneration of a target layer and the subsequent layers above the target layer of the container image. The traditional methods do not effectively differentiate between dependency files that have been changed and the dependency files that remain unchanged and can be reused. For example, if a developer updates a single library version in a large project, the entire set of dependency files may be reinstalled, even if many of the dependency files are already present in the local cache. These unnecessary installations not only increase the processing time for the generation of container images but also complicate the development process due to unnecessary rebuilds or unnecessary regenerations of the layers of the container images, which should have been reused.

Moreover, the potential for conflicting or inconsistent dependency file package versions further complicates the build process. Even when some of the dependency files are available in the local cache, the caching mechanism may still necessitate a complete reinstallation due to version mismatches. The situation of the complete reinstallation is particularly problematic in environments where multiple projects share dependency files, as differing version requirements can lead to conflicts that need additional troubleshooting. For instance, if two projects depend on different versions of the same library, the container image build process may fail or produce inconsistent results, thereby undermining the reliability of the deployment process. Therefore, there is a need for improved solutions for the generation of container images to resolve the problems associated with the traditional methods.

The disclosed system provides an improved way for the generation of container images, and more particularly to modification of container images using cache data. In some embodiments, when the disclosed system receives the dockerfile that includes the set of instructions for generating container images, the disclosed system firstly identifies that in case some of the received instructions in the dockerfile are for regenerating a target layer with new dependency files. Further, when the disclosed system identifies that the received instructions are for regenerating a target layer with new dependency files, the disclosed system obtains the original dependency files that have been cached by the caching mechanism from the cache data. In some embodiments, the disclosed system further compares a first parameter (e.g. package version) associated with each dependency file of the new dependency files with a second parameter (e.g. package version) associated with a corresponding dependency file of the original dependency files stored in the cache data, in order to determine the one or more dependency files that need to be updated. The disclosed system further installs or updates only the one or more dependency files that need to be updated, instead of reinstalling each of the new dependency files. Instead of comparing the entire dependency files, the disclosed system compares the first parameter and the second parameter, which reduces the processing time for determining the one or more dependency files that need to be updated, thereby reducing the overall processing time for the generation of the container image.

In some embodiments, instead of regenerating the target layer and the subsequent layers above the target layer, the disclosed system further generates the specific instructions for generating only a specific portion of the target layer. The data associated with the generated specific portion stores the updated one or more dependency files. A bit size of the generated specific portion is less than a bit size of the target layer since the specific portion is generated only for the updated one or more dependency files and not for each of the new dependency files. Apart from the specific portion, the disclosed system reutilizes various portions of the target layer that are associated with the cached dependency files which can be reused. The disclosed system further embeds the generated specific portion with the various portions of the target layer, and reuses the subsequent layers, to generate a modified container image.

Since the bit size of the generated specific portion is less than the bit size of the entire target layer, the processing time for the generation of the specific portion is less than the processing time for the regeneration of the entire target layer. Also, since the disclosed system eliminates the need for regenerating the entire target layer and all the subsequent layers above the target layer, the disclosed system reduces the processing time for the generation of the container images. In this manner, by accurately identifying dependency files that need modification, and generating only the specific portion that needs to be modified, the disclosed system avoids repeated installation of unchanged dependency files, which reduces the processing time for the container image build process and improves the efficiency of the container image build process.

The disclosed system further reduces the consumption of computing resources by eliminating the need for unnecessary reinstallations of the entire dependency files, especially when the dependency files of projects are large or numerous. The disclosed system further improves the caching mechanism, since the need for regenerating the entire target layer and the subsequent layers above the target layer is eliminated, thereby reducing unnecessary layer reconstruction, optimizing the use of the cache data, and improving the efficiency of the container image build process. Further, since the disclosed system utilizes the caching layer (the target layer) as much as possible and generates only the specific portion, hence the disclosed system further reduces the deployment time of the generated container image. Moreover, the disclosed system further reduces the overall cost for the generation of the container images by reducing the consumption of computing resources and eliminating the need for unnecessary reinstallations and unnecessary layer generations.

In various embodiments of the disclosure, a computer-implemented method for modification of container images using cache data is described. The computer-implemented method includes receiving, by a computer, a first set of instructions including a first directory path associated with a first set of dependency files of an application. The first set of instructions is associated with a regeneration of a specific layer of a container image. The container image is associated with the application. The regeneration of the specific layer is based on the first set of dependency files. The computer-implemented method further includes obtaining, by the computer, a second set of instructions associated with the specific layer. The second set of instructions includes a second directory path associated with a second set of dependency files of the application. The second set of instructions is obtained from the cache data. The cache data is associated with the container image. The computer-implemented method further includes comparing, by the computer, a first parameter associated with each dependency file of the first set of dependency files with a second parameter associated with a corresponding dependency file of the second set of dependency files. The computer-implemented method further includes generating, by the computer, at least one specific instruction for the specific layer based on the comparing of the first parameter with the second parameter. The at least one specific instruction is indicative of a modification of at least one dependency file of the second set of dependency files. The computer-implemented method further includes generating, by the computer, a specific portion of the specific layer based on the generated at least one specific instruction. The computer-implemented method further includes generating, by the computer, a modified container image of the application based on the generated specific portion. The computer-implemented method further includes outputting, by the computer, the modified container image.

In various embodiments of the disclosure, the computer-implemented method further includes embedding, by the computer, the generated specific portion to a set of layers associated with the container image. The set of layers includes the specific layer. The computer-implemented method further includes generating, by the computer, the modified container image based on the set of layers and the embedded specific portion. The computer-implemented method further includes storing, by the computer, the modified container image.

In various embodiments of the disclosure, the computer-implemented method further includes generating, by the computer, a layer identifier associated with the generated specific portion based on the generated at least one specific instruction. The computer-implemented method further includes modifying, by the computer, metadata associated with the set of layers by adding the generated layer identifier into a set of identifiers. The modified metadata includes the set of identifiers and the generated layer identifier. The set of identifiers is associated with the set of layers. The computer-implemented method further includes storing, by the computer, the modified metadata.

In various embodiments of the disclosure, the computer-implemented method further includes obtaining, by the computer, the stored modified container image based on the modified metadata. The computer-implemented method further includes controlling, by the computer, a deployment of a container to host the application. The controlling of the deployment of the container is based on the obtained modified container image.

In various embodiments of the disclosure, the modification of the at least one dependency file corresponds to a modification of at least one parameter associated with the at least one dependency file. The at least one parameter corresponds to at least one of a package version associated with the at least one dependency file, a package name associated with the at least one dependency file, or an environment variable associated with the at least one dependency file.

In various embodiments of the disclosure, the computer-implemented method further includes modifying, by the computer, the second set of instructions based on the first set of instructions. The modification of the second set of instructions corresponds to a replacement of the second set of instructions with the first set of instructions. The cache data includes the second set of instructions. The computer-implemented method further includes modifying, by the computer, the cache data based on the modified second set of instructions. The computer-implemented method further includes storing, by the computer, the modified cache data.

In various embodiments of the disclosure, the computer-implemented method further includes executing, by the computer, the generated at least one specific instruction. The computer-implemented method further includes modifying, by the computer, the at least one dependency file based on the execution of the at least one specific instruction. The computer-implemented method further includes generating, by the computer, the specific portion based on the at least one modified dependency file.

In various embodiments of the disclosure, the computer-implemented method further includes modifying, by the computer, the cache data by adding the at least one modified dependency file to the cache data. The computer-implemented method further includes storing, by the computer, the modified cache data.

In various embodiments of the disclosure, the computer-implemented method further includes obtaining, by the computer, the first set of dependency files associated with the first directory path, and the second set of dependency files associated with the second directory path. The computer-implemented method further includes parsing, by the computer, the obtained first set of dependency files and the obtained second set of dependency files. The computer-implemented method further includes determining, by the computer, the first parameter and the second parameter, based on the parsed first set of dependency files and the parsed second set of dependency files, respectively. The determining of first parameter and the second parameter is prior to the comparing of the first parameter with the second parameter.

In various embodiments of the disclosure, the computer-implemented method further includes comparing, by the computer, the first set of instructions with the second set of instructions. The computer-implemented method further includes determining, by the computer, each instruction of the first set of instructions is identical to a corresponding instruction of the second set of instructions, based on the comparison of the first set of instructions with the second set of instructions. The computer-implemented method further includes comparing, by the computer, the first parameter associated with each dependency file of the first set of dependency files with the second parameter associated with the corresponding dependency file of the second set of dependency files, based on the determination that each instruction of the first set of instructions is identical to the corresponding instruction of the second set of instructions. The computer-implemented method further includes generating, by the computer, the at least one specific instruction for the specific layer, based on the comparison of the first parameter with the second parameter, and the determination that each instruction of the first set of instructions is identical to the corresponding instruction of the second set of instructions.

In various embodiments of the disclosure, the first parameter corresponds to one of a package version associated with each dependency file of the first set of dependency files, a package name associated with each dependency file of the first set of dependency files, or an environment variable associated with each dependency file of the first set of dependency files.

In various embodiments of the disclosure, the second parameter corresponds to one of a package version associated with each dependency file of the second set of dependency files, a package name associated with each dependency file of the second set of dependency files, or an environment variable associated with each dependency file of the second set of dependency files.

In various embodiments of the disclosure, a bit size of the generated specific portion is less than a bit size of the specific layer. An execution time for the generating of the specific portion is less than an execution time for the regeneration of the specific layer.

In various embodiments of the disclosure, a computer system for modification of container images using cache data is described. The computer system includes a processor set, one or more computer-readable storage media, and program instructions stored on the one or more computer-readable storage media. The program instructions are executable by the processor set and cause the processor set to receive a first set of instructions including a first directory path associated with a first set of dependency files of an application. The first set of instructions is associated with a regeneration of a specific layer of a container image. The container image is associated with the application. The regeneration of the specific layer is based on the first set of dependency files. The program instructions further cause the processor set to obtain a second set of instructions associated with the specific layer. The second set of instructions includes a second directory path associated with a second set of dependency files of the application. The second set of instructions is obtained from the cache data. The cache data is associated with the container image. The cache data is associated with the container image. The program instructions further cause the processor set to compare a first parameter associated with each dependency file of the first set of dependency files with a second parameter associated with a corresponding dependency file of the second set of dependency files. The program instructions further cause the processor set to generate at least one specific instruction for the specific layer based on the comparison of the first parameter with the second parameter. The at least one specific instruction is indicative of a modification of at least one dependency file of the second set of dependency files. The program instructions further cause the processor set to generate a specific portion of the specific layer based on the generated at least one specific instruction. A bit size of the generated specific portion is less than a bit size of the specific layer. An execution time for the generation of the specific portion is less than an execution time for the regeneration of the specific layer. The program instructions further cause the processor set to generate a modified container image of the application based on the generated specific portion. The program instructions further cause the processor set to a control a deployment of a container to host the application. The control of the deployment of the container is based on the generated modified container image.

In various embodiments of the disclosure, the program instructions further cause the processor set to embed the generated specific portion to a set of layers associated with the container image. The set of layers includes the specific layer. The program instructions further cause the processor set to generate the modified container image, based on the set of layers and the embedded specific portion. The program instructions further cause the processor set to store the modified container image.

In various embodiments of the disclosure, the program instructions further cause the processor set to generate a layer identifier associated with the generated specific portion based on the generated at least one specific instruction. The program instructions further cause the processor set to modify metadata associated with the set of layers based on an addition of the generated layer identifier into a set of identifiers. The modified metadata includes the set of identifiers and the generated layer identifier. The set of identifiers is associated with the set of layers. The program instructions further cause the processor set to store the modified metadata.

In various embodiments of the disclosure, the program instructions further cause the processor set to obtain the stored modified container image based on the modified metadata. The program instructions further cause the processor set to control the deployment of the container to host the application. The control of the deployment of the container is based on the obtained modified container image.

In various embodiments of the disclosure, a bit size of the generated specific portion is less than a bit size of the specific layer. An execution time for the generating of the specific portion is less than an execution time for the regeneration of the specific layer.

In various embodiments of the disclosure, a computer-program product for modification of a specific layer of a container image is described. The computer program product includes one or more computer-readable storage media and program instructions stored in the one or more computer-readable storage media to perform operations that include receiving a first set of instructions including a first directory path associated with a first set of dependency files of an application. The first set of instructions is associated with a regeneration of the specific layer of the container image. The container image is associated with the application. The regeneration of the specific layer is based on the first set of dependency files. The operations further include obtaining a second set of instructions associated with the specific layer. The second set of instructions includes a second directory path associated with a second set of dependency files of the application. The second set of instructions is obtained from the cache data. The cache data is associated with the container image. The operations further include comparing a first parameter associated with each dependency file of the first set of dependency files with a second parameter associated with a corresponding dependency file of the second set of dependency files. The operations further include generating at least one specific instruction for the specific layer based on the comparing of the first parameter with the second parameter. The at least one specific instruction is indicative of a modification of at least one dependency file of the second set of dependency files. The operations further include generating a specific portion of the specific layer based on the generated at least one specific instruction. A bit size of the generated specific portion is less than a bit size of the specific layer. An execution time for the generating of the specific portion is less than an execution time for the regeneration of the specific layer. The operations further include generating a modified container image of the application based on the generated specific portion. The operations further include outputting the modified container image.

In various embodiments of the disclosure, a bit size of the generated specific portion is less than a bit size of the specific layer. An execution time for the generating of the specific portion is less than an execution time for the regeneration of the specific layer.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage media is an electronic storage media, a magnetic storage media, an optical storage media, an electromagnetic storage media, a semiconductor storage media, a mechanical storage media, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage media or mediums, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while stored.

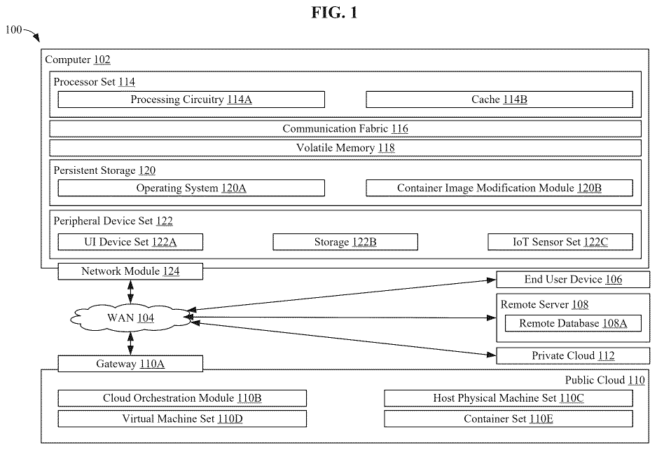

FIG. 1 is a diagram that illustrates a computing environment for modification of container images using cache data, in accordance with an embodiment of the disclosure. With reference to FIG. 1, there is shown a computing environment 100 that contains an example of an environment for the execution of at least some of the computer code involved in performing the disclosed methods, such as a container image modification module 120B. In addition to the container image modification module 120B, computing environment 100 includes, for example, a computer 102, a wide area network (WAN) 104, an end user device (EUD) 106, a remote server 108, a public cloud 110, and a private cloud 112. In an embodiment of the disclosure, the computer 102 includes a processor set 114 (including a processing circuitry 114A and a cache 114B), a communication fabric 116, a volatile memory 118, a persistent storage 120 (including an operating system 120A and the container image modification module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that can run a program, access a network or query a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the container image modification module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the container image modification module 120B typically includes at least some of the computer code involved in performing the disclosed methods.

The peripheral device set 122 includes the set of peripheral devices of computer 102. Data communication connections between the peripheral devices and the various components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, the storage 122B may take the form of a quantum computing storage device for storing data in the form of qubits. In embodiments of the disclosure where the computer 102 is needed to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with various computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through WAN 104 to EUD 106. In this way, the EUD 106 can display, or otherwise present recommendations to an end user. In some embodiments of the disclosure, the EUD 106 may be a client device, such as a mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in the containers. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is shown as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

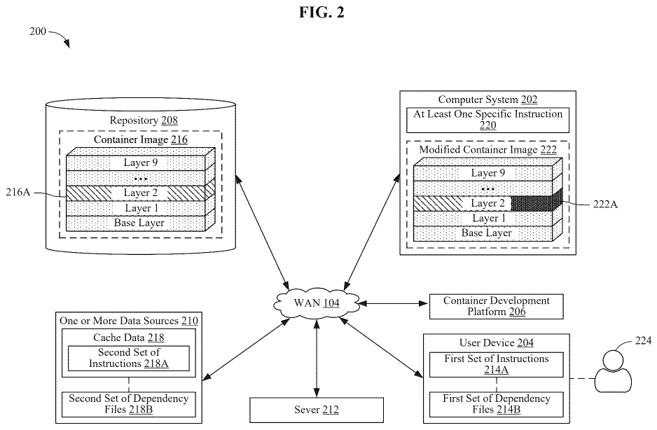

FIG. 2 is a diagram that illustrates an environment for modification of container images using cache data, in accordance with an embodiment of the disclosure. FIG. 2 is explained in conjunction with elements from FIG. 1. With reference to FIG. 2, there is shown a diagram of a network environment 200. The network environment 200 includes a computer system 202 (maybe referred to as a system 202 hereinafter), a user device 204, a container development platform 206, a repository 208, one or more data sources 210, and a server 212. The system 202 is configured to receive a first set of instructions 214A from the user device 204. The first set of instructions 214A is associated with a first set of dependency files 214B of an application. The system 202 may be further configured to generate a container image 216 of the application. The first set of instructions 214A is associated with a regeneration of a specific layer 216A of the container image 216. The repository 208 is configured to store a set of container images (e.g. the container image 216). The one or more data sources 210 stores the cache data 218 associated with the generated container image 216. The cache data 218 includes a second set of instructions 218A. The second set of instructions 218A is associated with a second set of dependency files 218B of the application. The system 202 may be configured to generate at least one specific instruction 220 for generating a modified container image 222 of the application. The system 202 may be further configured to generate a specific portion 222A (may also be referred to as a fixpack layer 222A, hereinafter) of the specific layer 216A. The user device 204 is further associated with a user 224. The network environment 200 further includes the WAN 104 of FIG. 1. In an embodiment of the disclosure, the user device 204 is an exemplary embodiment of the EUD 106. Similarly, the computer system 202 is an exemplary embodiment of the computer 102 in FIG. 1.

The system 202 includes suitable logic, circuitry, code, and/or interfaces that are configured to modify the specific layer 216A of the container image 216 by generating only the specific portion 222A (the fixpack layer 222A) of the specific layer, during a build stage of the container image 216, by using the cache data 218. In an embodiment, the system 202 is configured to receive the first set of instructions 214A which includes a first directory path associated with the first set of dependency files 214B of the application. The system 202 is further configured to obtain the second set of instructions 218A which includes a second directory path associated with the second set of dependency files 218B of the application. The second set of instructions 218A is obtained from the cache data 218. The system 202 is further configured to compare a first parameter associated with each dependency file of the first set of dependency files 214B with a second parameter associated with a corresponding dependency file of the second set of dependency files 218B. The system 202 is further configured to generate the at least one specific instruction 220 for the specific layer 216A based on the comparison of the first parameter with the second parameter. The at least one specific instruction 220 is indicative of a modification of at least one dependency file of the second set of dependency files. The system 202 is further configured to generate the specific portion 222A of the specific layer 216A based on the generated at least one specific instruction 220. A bit size of the generated specific portion 222A is less than a bit size of the specific layer 216A. An execution time for the generation of the specific portion 222A is less than an execution time for the regeneration of the specific layer 216A. The system 202 is further configured to generate the modified container image 222 of the application based on the generated specific portion 222A. The system 202 is further configured to output the modified container image 222.

Examples of the system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the system 202 may be embodied as a cloud-based service, a cloud-based application, a cloud-based platform, a remote server-based service, a remote server-based application, a remote server-based platform, or a virtual computing system.

The user device 204 includes suitable logic, circuitry, and/or interfaces that are configured to execute one or more tasks within the network environment 200. The user device 204 performs the one or more tasks such as receiving data, processing the data, and transmitting the data. In an embodiment of the disclosure, the system 202 is configured to receive the first set of instructions 214A from the user device 204. The first set of instructions 214A may be associated with the regeneration of the specific layer 216A of the container image 216. Examples of each instruction of the first set of instructions 214A include at least one of but are not limited to, a “RUN” instruction, an “ADD” instruction, a “FROM” instruction, or a “COPY” instruction. In an embodiment, the first set of instructions 214A further includes the first directory path associated with the first set of dependency files 214B. In an embodiment, the regeneration of the specific layer is based on the first set of dependency files 214B. For example, the first set of instructions 214A “RUN pip install -r /app/requirements.txt” includes the first directory path “./app/requirements.txt” and the first set of dependency files 214B associated with the first directory path may be “flask 2.2.0, numpy 1.25.0, and pandas 1.5.3”.

In an alternate embodiment, the computer system 202 renders a message on the user device 204. The message is associated with the generation of the modified container image 222 of the application. By way of example, and not by limitation, the message may be “The container image of the application has been successfully generated”. Examples of the user device 204 include but are not limited to, a smartphone, a cellular phone, a mobile phone, a consumer electronic (CE) device, an Internet of Things (IoT) device, a computing device, a mainframe machine, a server, a computer workstation, or the like.

The application may include suitable logic and/or code that is designed to perform specific tasks or functions, which can range from web services to data processing tools. Specifically, the application may be built using various programming languages and frameworks, and the application relies on specific dependencies and configurations to operate effectively. By way of example, and not by limitation, the application could be a website that serves dynamic content, a database management system, a microservice that handles user authentication, and the like.

The container development platform 206 includes suitable logic, circuitry, code/and or interfaces to create, build, test, and deploy containerized applications. The container development platform 206 packages the applications along with the dependencies of the application into lightweight, portable containers that can run consistently across various computing environments. The container development platform 206 ensures that the applications operate uniformly, regardless of the underlying infrastructure.

In an embodiment, the container development platform 206 is configured to generate the container image 216 of the application. Specifically, the container development platform 206 allows developers to define application environments using configuration files (e.g. dockerfiles). The application environments refer to the specific configurations and settings in which the application runs, encompassing the software dependencies, runtime libraries, environment variables. The container development platform 206 also provides local development environments that simulate production settings, enabling developers to test applications in isolation before deployment. Additionally, the container development platform 206 further integrates with the repository 208 (e.g. a storage unit for the container images) for storing and sharing images, as well as with container orchestration platforms for managing container deployment and scaling in production environments.

The container development platform 206 provides several advantages that include enhanced portability, improved resource efficiency, and streamlined development workflows. By abstracting the complexities of the underlying infrastructure, the container development platform 206 empowers developers to focus on writing code and delivering the applications quickly and reliably.

In an embodiment of the disclosure, the container development platform 206 is implemented as a plurality of distributed cloud-based resources by use of several technologies that are well known to those who are ordinarily skilled in the art. A person with ordinary skill in the art will understand that the scope of the disclosure may not be limited to the implementation of the container development platform 206 and the computer system 202 as two separate entities. In certain embodiments, the functionalities of the container development platform 206 can be incorporated in its entirety or at least partially in the computer system 202, without a departure from the scope of the disclosure.

The repository 208 includes suitable logic, circuitry, code, and interfaces to store, manage, and distribute container images (e.g. the container image 216 and the generated modified container image 222). The repository 208 serves as a centralized storage unit for container images that encapsulate applications and the dependencies of the applications. The repository 208 is critical for maintaining a consistent and reliable environment for deploying the applications across various stages of development, testing, and production. In an embodiment of the disclosure, the system 202 may be configured to obtain the container image 216 from the repository 208 and store the generated modified container image 222 in the repository 208. The repository 208 operates by utilizing a set of protocols and APIs that allow the system 202 to interact with the stored container images.

In an embodiment, the repository 208 may be configured to store the generated modified container image 222. In an embodiment, the system 202 may be configured to push new container images to the repository 208 and pull existing container images from the repository 208 for deployment. The system 202 may further be configured to manage a set of identifiers associated with the container images such as image tags or image hashes to indicate different versions or configurations. In an embodiment, the system 202 pushes the modified container image 222 to the repository 208 and modifies the set of identifiers associated with the container image 216 to indicate that the modified container image 222 has been stored. The system 202 can further identify and verify that the new version has been stored successfully based on the set of identifiers. In this manner, the system 202 ensures that the repository stores the latest version of the container images. The repository 208 may also implement access control mechanisms to ensure that only authorized sources can modify or retrieve container images. Examples of the repository 208 include public options like those that provide open-source images and private repositories that organizations can host internally.

The container image 216 of the application is a lightweight, standalone, and executable package that includes suitable logic and/or code that is needed to run the application on various container orchestration platforms. The container image 216 includes application code, runtime environment, libraries, and system tools associated with the application that are needed to run the application on the various container orchestration platforms. In an embodiment, the container image 216 has a layered architecture (that includes a base layer and a set of layers/a set of image layers/a set of data layers (e.g. image layer 2, image layer 3) (may also be referred to as a set of layers, hereinafter). The set of layers represents the layers of the container image, which are read-only.

The set of layers represents the read-only layers of the container image 216 that store the application code, libraries, and system tools associated with the application that are needed to run the application on the various container orchestration platforms. The advantages of using the layered architecture include faster image builds, reduced storage requirements, and improved caching mechanisms. By reusing existing layers, the system 202 can build new container images more quickly, as only the changes need to be processed. This layered architecture also allows for critical updates, as only the modified layers need to be pushed to the repository 208.

Each data source of the one or more data sources 210 corresponds to an organized collection of data that may be stored and accessed electronically from a computer system (such as the computer system 202). Each of the one or more data sources 210 may be designed to manage, store, retrieve, and update data efficiently. In an exemplary implementation, each data source of the one or more data sources 210 may correspond to a database. In such an implementation, the structure of the database corresponding to each data source of the one or more data sources 210 typically involves tables, records, and fields that can be managed through various database management systems (DBMS).

In an embodiment of the disclosure, the one or more data sources 210 are connected to the application programming interfaces (APIs) of the container development platform 206 and the repository 208. In an embodiment, each data source of the one or more data sources stores the cache data 218 associated with the container image 216. The cache data 218 may include binary contents for quick retrieval of the container image 216 during image builds or deployments. The cache data 218 may include further include the data associated with the build process of each layer of the set of layers. In an embodiment, the cache data 218 associated with each layer of the set of layers may include a specific set of instructions that may be utilized to generate a respective layer of the set of layers of the container image 216. In an embodiment, the cache data 218 may include the second set of instructions 218A associated with the specific layer 216A. The second set of instructions 218A corresponds to the instructions that may be utilized for the generation of the specific layer 216A during the generation of the container image 216. In an embodiment, the second set of instructions 218A may further include a second directory path associated with the second set of dependency files 218B. In an embodiment, the generation of the specific layer 216A may be based on the second set of dependency files 218B. For example, the second set of instructions 218A “RUN pip install -r /app/requirements.txt“includes the second directory path”./app/requirements.txt”, and the second set of dependency files 218B associated with the second directory path may be “flask 2.3.2, numpy 1.24.2, and pandas 1.5.3”.

Examples of each data source of one or more data sources 210 may include but are not limited to, a relational database, a Non-Structured Query Language (SQL) database, a hierarchical database, a network database, a transactional database, a data warehouse, and a distributed database.

The server 212 includes suitable logic, circuitry, interfaces, and/or code that stores the first set of instructions 214A, the second set of instructions 218A, the container image 216, and the generated modified container image 222. The server 212 can be implemented as a cloud server and may execute operations through web applications, cloud applications, HTTP requests, repository operations, file transfer, and the like. Various example implementations of the server 212 include but are not limited to, a database server, a file server, a web server, a media server, an application server, a mainframe server, or a cloud computing server.

In an embodiment of the disclosure, the server 212 is implemented as a plurality of distributed cloud-based resources by use of several technologies that are well known to those ordinarily skilled in the art. A person with ordinary skill in the art will understand that the scope of the disclosure may not be limited to the implementation of the server 212 and the computer system 202 as two separate entities. In certain embodiments, the functionalities of the server 212 can be incorporated in its entirety or at least partially in the computer system 202, without a departure from the scope of the disclosure.

In operation, the system 202 is configured to receive the first set of instructions 214A associated with the regeneration of the specific layer 216A of the container image 216, from the user device 204. In an embodiment, the user 224 intends to modify the dependencies of the application. By way of example, and not by limitation, the user 224 may intend to modify the dependencies of the application in case of any vulnerabilities, in case of new package versions of dependency files, or in case of any issues with existing package versions. In this scenario, the system 202 receives the first set of instructions 214A for the regeneration of the specific layer 216A. The specific layer 216A may be any layer of the set of layers, that may be associated with the critical dependency files of the application, that the user 224 may intend to modify. In an embodiment, the first set of instructions 214A includes the first directory path associated with the first set of dependency files 214B of the application. The first set of dependency files 214B indicates the modified dependency files that needs to be associated with the application for the smooth functioning of the application. The regeneration of the specific layer 216A is based on the first set of dependency files 214B. The first directory path refers to a specific location or a specific address that indicates where the first set of dependency files 214B are stored. In general, dependency files refer to the files that specify the libraries, packages, and various resources that are needed for the application to run correctly within the containerized environments. These dependency files are critical for ensuring that the application has all the vital components that are needed by the application.

By way of example, and not by limitation, the system 202 receives the first set of instructions 214A as:
FROM python:3.9-slim
COPY requirements.txt /app/
RUN pip install -r /app/requirements.txt
COPY. /app/
WORKDIR /app
CMD [“python”, “app.py”]

In this example, the first set of instructions 214A is associated with the regeneration of the layer 2 of the container image 216 of the application. The first set of instructions 214A includes the first directory path “/app/requirements.txt” that includes the “requirements.txt” file. In the “requirements.txt” file, the first set of dependency files 214B associated with the first directory path may be “flask 2.2.0, numpy 1.25.0, pandas 1.5.3, sqlalchemy 2.0.5, and gunicorn 20.1.0”.

Thereafter, the system 202 is configured to obtain the second set of instructions 218A associated with the specific layer 216A, from the cache data 218. In an embodiment, the system 202 is configured to obtain the cache data 218 associated with the container image 216 from the one or more data sources 210 and then obtain the second set of instructions 218A associated with the specific layer 216A from the cache data 218. The second set of instructions 218A refers to the instructions that may be utilized during the historical build of the specific layer 216A. By way of example, and not by limitation, the historical build of the specific layer 216A may take place 10 seconds, 30 seconds, 10 minutes, 30 minutes, or even 1 hour before the reception of the first set of instructions 214A. As discussed above, the system 202 (or the container development platform 206) is configured to store the data associated with the build process of each layer of the set of layers in the cache data 218. In an embodiment, the cache data 218 associated with each layer of the set of layers may include the specific set of instructions that may be utilized to generate the respective layer of the set of layers of the container image 216. In an embodiment, the second set of instructions 218A includes the second directory path that may be associated with the second set of dependency files 218B of the application. The second set of dependency files 218B indicates the dependency files that were utilized during the historical build of the specific layer 216A.

By way of example, and not by limitation, the system 202 obtains the second set of instructions 218A provided in Table 1:

TABLE 1
Second Set of Instructions

| Time- | | |
|---|---|---|
| stamp | Instructions | Bit Size |
| 10 sec ago | /bin/sh -c COPY . /app/ | 5 MB |
| 20 sec ago | /bin/sh -c RUN pip install -r /app/requirements.txt | 100 MB |
| 30 sec ago | /bin/sh -c COPY requirements.txt /app/ | 1.2 KB |
| 40 sec ago | /bin/sh -c FROM python:3.9-slim | 29 MB |

In this example, the second set of instructions 218A includes the second directory path “/app/requirements.txt” that includes the “requirements.txt” file. In the “requirements.txt” file, that was used for the generation of the layer 2 (20 seconds ago), the second set of dependency files 218B associated with the second directory path may be “flask 2.3.2, numpy 1.24.2, pandas 1.5.3, sqlalchemy 2.0.5, and gunicorn 20.1.0”. Also, the bit size for the regeneration of the specific layer 216A is 100 MB as illustrated in the table.

Further, the system 202 is configured to compare the first parameter associated with each dependency file of the first set of dependency files 214B with the second parameter associated with the corresponding dependency file of the second set of dependency files 218B. In an embodiment, the first parameter and the second parameter correspond to one of a package version, a package name, or an environment variable associated with each dependency file of the first set of dependency files 214B and each dependency file of the second set of dependency files 218B, respectively. The system 202 may be configured to compare the first parameter with the second parameter to identify whether a modification in any of the second set of dependency files 218B (that were used during the historical build) is needed. In addition to comparing the entire dependency files, the system 202 is also configured to identify the modification based on the comparison of the first parameter and the second parameter, which reduces the processing time of the identification of the modification that is needed in the second set of dependency files 218B, thereby further reducing the processing time for the generation of the modified container image 222. The modification of the second set of dependency files 218B may correspond to an upgrade or a downgrade of the package version of a specific dependency file, an addition of the specific dependency file (indicated by a new package name in the first set of dependency files), a deletion of the specific dependency file (indicated when a package name is missing in the first set of dependency files), or a modification in the environment variable associated with the specific dependency file.

By way of example, and not by limitation, the system 202 compares the package version of each dependency file of the first set of dependency files 214B (flask 2.2.0, numpy 1.25.0, pandas 1.5.3, sqlalchemy 2.0.5, and gunicorn 20.1.0) with the package version of the corresponding dependency file of the second set of dependency files 218B (flask 2.3.2, numpy 1.24.2, pandas 1.5.3, sqlalchemy 2.0.5, and gunicorn 20.1.0). Based on the comparison, the system 202 identifies that the package version of flask is downgraded from 2.3.2 to 2.2.0 and the package version of numpy is upgraded from 1.24.2 to 1.25.0, and the rest of the dependency files are the same.

Thereafter, the system 202 is configured to generate the at least one specific instruction 220 for the specific layer 216A, based on the comparison of the first parameter with the second parameter. In an embodiment, the at least one specific instruction 220 is indicative of the modification of at least one dependency file of the second set of dependency files 218B. As discussed above, the modification may correspond to an upgrade or a downgrade of the package version of the at least one dependency file, an addition of a specific dependency file (indicated by a new package name in the first set of dependency files), a deletion of a specific dependency file (indicated when a package name is missing in the first set of dependency files), or a modification in the environment variable associated with the at least one dependency file. In an embodiment, the system 202 may be configured to generate the at least one specific instruction 220 based on the identified modification in the second set of dependency files 218B, for implementing the identified modification in the container image 216. By way of example, and not by limitation, the system 202 generates the at least one specific instruction 220 as “RUN pip install -upgrade numpy==1.25.0 flask==2.2.0” as the identified modification was that the package version of flask needed to be downgraded from 2.3.2 to 2.2.0 and the package version of numpy needed to be upgraded from 1.24.2 to 1.25.0, and rest of the dependency files are the same. Also, the bit size of the generated at least one specific instruction is just 1 KB, which is much less than the bit size of the instruction “RUN pip install -r /app/requirements.txt” (100 MB), provided in Table 1.

Further, the system 202 is configured to generate the specific portion 222A (the fixpack layer 222A) of the specific layer 216A based on the generated at least one specific instruction 220. The system 202 may be configured to execute the generated at least one specific instruction 220 and then generate the fixpack layer 222A based on the execution of the generated at least one specific instruction 220. The cache data 218 associated with the fixpack layer 222A may include the at least one modified dependency file and the generated at least one specific instruction 220. Instead of regenerating the entire specific layer 216A of the container image 216, the system 202 is configured to generate only the specific portion 222A (the fixpack layer 222A) of the specific layer 216A. The bit size of the generated specific portion 222A (the fixpack layer 222A) is less than the bit size of the specific layer since only the at least one modified dependency file needs to be added in the cache data 218 associated with the generated specific portion 222A. The execution time for the generation of the specific portion 222A (the fixpack layer 222A) is less than the execution time for the regeneration of the specific layer as the system 202 needs to execute only the at least one specific instruction 220 and not the entire first set of instructions 214A, and also the bit size of the generated specific portion is less than the bit size of the specific layer 216A. As the execution time for the generation of the specific portion 222A (the fixpack layer 222A) is less than the execution time for the regeneration of the specific layer, the overall processing time is reduced for the generation of the modified container image 222. By way of example, and not by limitation, the system 202 generates the fixpack layer 222A based on the execution of the at least one specific instruction 220 “RUN pip install -upgrade numpy==1.25.0 flask==2.2.0”. The system 202 further updates the package version of the numpy and flask accordingly in the cache data 218, and further replaces the second set of instructions 218A with the first set of instructions 214A in the cache data 218. Also, the bit size of the fixpack layer 222A generated by the at least one specific instruction “RUN pip install -upgrade numpy==1.25.0 flask==2.2.0” (1 KB) is much less than the instructions for the regenerating the entire specific layer “RUN pip install -r /app/requirements.txt” (100 MB).

Thereafter, the system 202 is configured to generate the modified container image 222 of the application based on the generated specific portion 222A (the fixpack layer 222A). In an embodiment, the system 202 is configured to embed the specific portion 222A (the fixpack layer 222A) into the specific layer 216A of the set of layers of the container image 216 and then generate the modified container image 222 based on the embedded specific portion 222A and the set of layers. The modified container image 222 includes the fixpack layer 222A embedded with the original container image 216. The system 202 is further configured to update the cache data 218 associated with the generated modified container image 222 with the at least one modified dependency file and the first set of instructions 214A. The update of the cache data 218 corresponds to the addition of the at least one modified dependency file and the replacement of the second set of instructions 218A with the first set of instructions 214A in the cache data 218. Instead of regenerating the entire specific layer, the system 202 generates only the specific portion 222A and the execution time for the generation of the specific portion 222A (the fixpack layer 222A) is less than the execution time for the regeneration of the specific layer, hence the system 202 reduces the overall processing time for the generation of the modified container image 222.

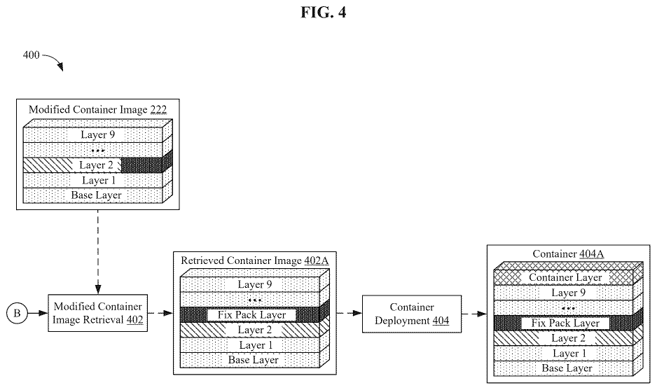

To this end, the system 202 is configured to output the generated modified container image 222. In an embodiment, the system 202 is configured to store (push) the generated modified container image 222 in the repository 208. In an alternate embodiment, the system 202 is configured to render the message associated with the generation of the modified container image 222 on the user device 204. In an alternate embodiment, the system 202 may be further configured to initialize a container to run the generated modified container image 222. Details about the initialization of the container are further provided, for example, in FIG. 4.

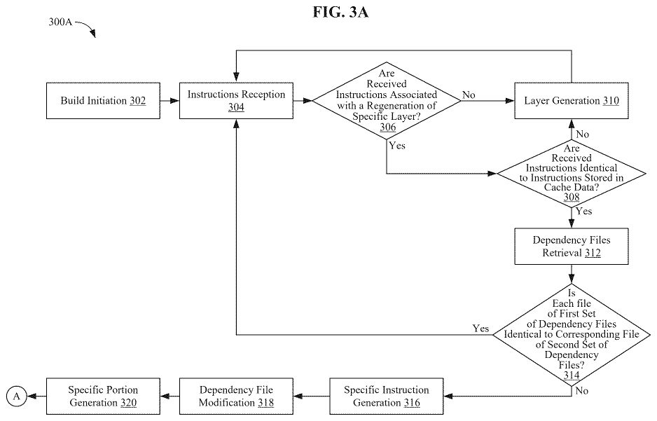

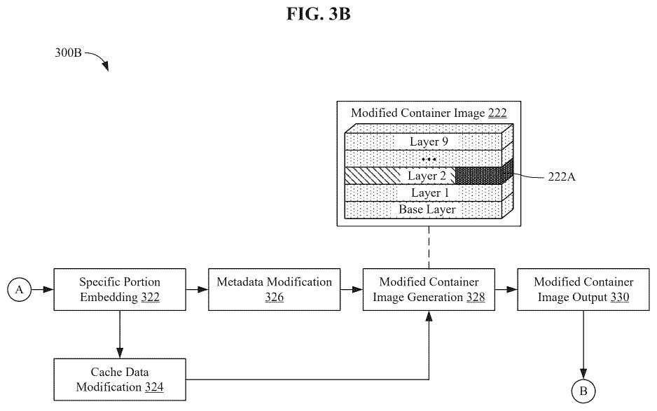

FIG. 3A is a diagram that illustrates exemplary operations for the generation of a specific portion of a specific layer for modification of container images using cache data, in accordance with an embodiment of the disclosure. FIG. 3A is explained in conjunction with elements from FIG. 1 and FIG. 2. With reference to FIG. 3A, there is shown a block diagram 300A that illustrates exemplary operations from 302 to 320, as described herein. The exemplary operations illustrated in the block diagram 300A start at 302 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300A can be divided into additional blocks, combined into fewer blocks, or eliminated, depending on the implementation.

At 302, a build initiation operation is performed. In the build initiation operation, the system 202 is configured to initiate the build process of the container image 216. In an embodiment, the system 202 initializes the build process of the container image 216 by establishing a build context, which is a directory that contains the files that are critical for the generation of the base layer of the container image 216. The system 202 further identifies a specified base layer for the container image 216 and pulls (or obtains) the specified base layer from the repository in case the specified base layer is not present locally in the container development platform 206. The system 202 is further configured to set up the environment for the generation of the container image 216 based on the specified base layer. The initiation of the build process ensures that the vital resources are in place for the subsequent build step.

At 304, an instructions reception operation is performed. In the instructions reception operation, the system 202 is configured to receive specific instructions for the generation of the container image 216 of the application, after the build initiation operation. In an embodiment, the system 202 is configured to utilize the specific instructions to generate the set of layers of the container image 216. The specific instructions include the instructions that generate a new layer in the set of layers such as a “RUN” instruction, an “ADD” instruction, a “FROM” instruction, a “COPY” instruction, or the like. For each of the instructions that generate a new layer in the set of layers, the system 202 is configured to generate the corresponding layer in the set of layers. In an embodiment, the system 202 is configured to generate the corresponding layer and store the specific instructions in the cache data 218, which are used for the generation of the corresponding layer. The specific instructions further include the instructions that do not generate the new layer in the set of layers such as a “CMD” instruction, a “WORKDIR” instruction, or the like. It may be noted that the FIG. 3 illustrates an exemplary implementation of the system 202, in which the system 202 is implemented as a part of the container image build process.

By way of example, and not by limitation, during a build process, at a timestamp t1, the system 202 receives the specific instructions in the form of the first set of instructions 214A, as:
FROM python:3.9-slim
COPY requirements.txt /app/
RUN pip install -r /app/requirements.txt
COPY. /app/
WORKDIR /app
CMD [“python”, “app.py”]

At 306, it is determined that the received instructions are associated with the regeneration of the specific layer 216A. In an embodiment, the system 202 is configured to determine that the received instructions are associated with the regeneration of the specific layer 216A. In an embodiment, the user 224 intends to modify the dependencies of the application. By way of example, and not by limitation, the user 224 may intend to modify the dependencies of the application in case of any vulnerabilities, in case of new package versions of dependency files, or in case of any issues with existing package versions. In that scenario, the system 202 receives the first set of instructions 214A for the regeneration of the specific layer 216A. In an embodiment, the system 202 determines a presence of the received instructions within the cache data 218 to determine whether the received instructions are associated with the regeneration of the specific layer 216A or not. In case the system 202 determines that the received instructions are present within the cache data 218, then the system 202 determines that the received instructions are the first set of instructions 214A, which are associated with the regeneration of the specific layer 216A. Based on the determination that the received instructions are associated with the regeneration of the specific layer 216A, the control of operations proceeds to 308.

Alternatively, in a case where the system 202 determines that the received instructions are absent within the cache data 218, then the system 202 determines that the received instructions are not associated with the regeneration of the specific layer 216A and rather the received instructions are for the generation of a subsequent layer in the set of layers. Based on the determination that the received instructions are not associated with the regeneration of the specific layer 216A, the control of operations proceeds to 310, to generate a subsequent layer in the set of layers.

By way of example, and not by limitation, the system 202 determines the presence of the received instructions (given above) in the instructions stored in the cache data 218 (the second set of instructions 218A), which may be stored at a timestamp t2 before the timestamp t1. Hence, the system 202 determines that the received instructions are associated with the regeneration of the specific layer 216A. The second set of instructions 218A is provided in Table 2 below:

TABLE 2
Second Set of Instructions

| Time- | | |
|---|---|---|
| stamp | Instructions | Bit Size |
| 10 sec ago | /bin/sh -c COPY . /app/ | 5 MB |
| 20 sec ago | /bin/sh -c RUN pip install -r /app/requirements.txt | 100 MB |
| 30 sec ago | /bin/sh -c COPY requirements.txt /app/ | 1.2 KB |
| 40 sec ago | /bin/sh -c FROM python:3.9-slim | 29 MB |

At 308, it is determined that the received instructions are identical to the instructions stored in the cache data 218, based on the determination that the received instructions are associated with the regeneration of the specific layer 216A. In an embodiment, the system 202 is configured to compare each instruction of the first set of instructions 214A (the received instructions) with a corresponding instruction of the second set of instructions 218A to determine that each instruction of the first set of instructions 214A is identical to the corresponding instruction of the second set of instructions 218A. Based on the determination that the received instructions are identical to the instructions stored in the cache data 218, the control of operations proceeds to 312, otherwise, the control of operations proceeds to 310 to generate the subsequent layer in the set of layers of the container image 216.

By way of example, and not by limitation, as illustrated in Table 2 provided above, the system 202 determines that each instruction of the first set of instructions 214A (given above) is identical to the corresponding instruction in the second set of instructions 218A (provided in Table 2), hence the control of operations proceeds to 312. It may be noted that only the instructions that generate the corresponding layer in the set of layers are being compared and not the instructions that do not generate the corresponding layer since the instructions that do not generate the corresponding layer are not stored in the cache data 218.

At 310, a layer generation operation is performed. In the layer generation operation, the system 202 is configured to generate the subsequent layer in the set of layers of the container image 216 based on the determination that the received instructions are not associated with the regeneration of the specific layer 216A. In an alternate embodiment, the system 202 is further configured to generate the subsequent layer based on the determination that each instruction of the first set of instructions 214A is not identical to the corresponding instruction of the second set of instructions 218A. As discussed above, for each of the instructions that generate a new layer in the set of layers, such as the “RUN” instruction, the “ADD” instruction, the “FROM” instruction, the “COPY” instruction, or the like, the system 202 is configured to generate the corresponding layer in the set of layers.

At 312, a dependency files retrieval operation is performed. In the dependency files retrieval operation, the system 202 is configured to obtain the first set of dependency files 214B and the second set of dependency files 218B, based on the determination that each instruction of the first set of instructions 214A is identical to the corresponding instruction of the second set of instructions 218A. As discussed above, the first set of instructions 214A includes the first directory path associated with the first set of dependency files 214B of the application. The first set of dependency files 214B indicates the modified dependency files that the user 224 intends to be associated with the application for the smooth functioning of the application. The regeneration of the specific layer 216A is based on the first set of dependency files 214B. The second set of instructions 218A includes the second directory path that may be associated with the second set of dependency files 218B of the application. The second of dependency files 218B indicates the dependency files that were utilized during the historical build (at timestamp t2) of the specific layer 216A In an embodiment, the system 202 is configured to obtain the first set of dependency files 214B and the second set of dependency files 218B based on the first directory path associated with the received first set of instructions 214A and the second directory path associated with the obtained second set of instructions 218A, respectively.

In an embodiment, the system 202 may be further configured to determine the first parameter associated with each dependency file of the obtained first set of dependency files 214B and the second parameter associated with each dependency file of the obtained second set of dependency files 218B. The system 202 may be configured to parse the obtained first set of dependency files 214B and the obtained second set of dependency files 218B to determine the first parameter and the second parameter, respectively. In an embodiment, the first parameter and the second parameter correspond to one of the package version, the package name, or the environment variable associated with each dependency file of the first set of dependency files 214B and each dependency file of the second set of dependency files 218B, respectively.

By way of example, and not by limitation, in the first set of instructions 214A provided above, which are received at the timestamp t1, the first set of instructions 214A includes the first directory path “/app/requirements.txt” that includes the “requirements.txt” file. In the “requirements.txt” file, received at the timestamp t1, the first set of dependency files 214B associated with the first directory path are “flask 2.2.0, numpy 1.25.0, scikit-learn 1.3.1, sqlalchemy 2.0.5, and gunicorn 20.1.0”. The system 202 determines the first parameter associated with the first set of dependency files as the package versions and the package names.

By way of example, and not by limitation, as illustrated in Table 2 above, the second set of instructions 218A, stored at timestamp t2, includes the second directory path “/app/requirements.txt” that includes the “requirements.txt” file. In the “requirements.txt” file, that was used for the generation of the layer 2 (20 seconds ago), the second set of dependency files 218B associated with the second directory path may be “flask 2.3.2, numpy 1.24.2, pandas 1.5.3, sqlalchemy 2.0.5, and gunicorn 20.1.0”. The system 202 further determines the second parameter associated with the second set of dependency files as the package versions and the package names.

At 314, it is determined that each dependency file of the first set of dependency files 214B is identical to the corresponding dependency file of the second set of dependency files 218B. In an embodiment, the system 202 is configured to compare each dependency file of the first set of dependency files 214B with the corresponding dependency file of the second set of dependency files 218B to determine that each dependency file of the first set of dependency files 214B is identical to the corresponding dependency file of the second set of dependency files 218B or not. In case each dependency file of the first set of dependency files 214B is identical to the corresponding dependency file of the second set of dependency files 218B, this indicates that there is no need to regenerate the specific layer 216A since there is no modification in any of the dependency files. Hence, based on the determination that each dependency file of the first set of dependency files 214B is identical to the corresponding dependency file of the second set of dependency files 218B then the control of operations moves back to 304 for the reception of further specific instructions for the generation of the container image 216 or for generation of the modified container image 222. Otherwise, the control of operations proceeds to 316 for the generation of the at least one specific instruction 220, which is utilized for the generation of the specific portion 222A of the specific layer 216A that needs to be regenerated.

In an alternate embodiment, the system 202 is further configured to compare the first parameter associated with each dependency file of the first set of dependency files 214B with the second parameter associated with the corresponding dependency file of the second set of dependency files 218B to determine that each dependency file of the first set of dependency files 214B is identical to the corresponding dependency file of the second set of dependency files 218B or not. The system 202 may be configured to compare the first parameter with the second parameter to identify whether a modification in any of the second set of dependency files 218B (that were used during the historical build) is needed. In addition to comparing the entire dependency files, the system 202 is also configured to identify the modification based on the comparison of the first parameter and the second parameter, which reduces the processing time of the identification of the modification that is needed in the second set of dependency files 218B, thereby further reducing the processing time for the generation of the modified container image 222. The modification of the second set of dependency files 218B may correspond to an upgrade or a downgrade of the package version of a specific dependency file, an addition of the specific dependency file (indicated by a new package name in the first set of dependency files), a deletion of the specific dependency file (indicated when a package name is missing in the first set of dependency files), or a modification in the environment variable associated with the specific dependency file. Based on the identification that the modification is needed, the control of operations proceeds to 316 for the generation of the at least one specific instruction 220, which is utilized for the generation of the specific portion 222A of the specific layer 216A that needs to be regenerated.

By way of example, and not by limitation, the system 202 compares the package version and package name of each dependency file of the first set of dependency files 214B (flask 2.2.0, numpy 1.25.0, scikit-learn 1.3.1, sqlalchemy 2.0.5, and gunicorn 20.1.0) with the package version of the corresponding dependency file of the second set of dependency files 218B (flask 2.3.2, numpy 1.24.2, pandas 1.5.3, sqlalchemy 2.0.5, and gunicorn 20.1.0). Based on the comparison, the system 202 identifies that the package version of flask is downgraded from 2.3.2 to 2.2.0 and the package version of numpy is upgraded from 1.24.2 to 1.25.0, a new dependency file “scikit-learn 1.3.1” needs to be installed, a dependency file “pandas 1.5.3” can be uninstalled, and rest of the dependency files are the same.

At 316, a specific instruction generation operation is performed. In the specific instruction generation operation, the system 202 is configured to generate the at least one specific instruction 220 for the specific layer 216A, based on the determination that each dependency file of the first set of dependency files 214B is not identical to the corresponding dependency file of the second set of dependency files 218B and the modification is needed in the second set of dependency files 218B. In an embodiment, the at least one specific instruction 220 is indicative of the modification of at least one dependency file of the second set of dependency files 218B. As discussed above, the modification may correspond to an upgrade or a downgrade of the package version of the at least one dependency file, an addition of a specific dependency file (indicated by a new package name in the first set of dependency files), a deletion of a specific dependency file (indicated when a package name is missing in the first set of dependency files), or a modification in the environment variable associated with the at least one dependency file. In an embodiment, the system 202 may be configured to generate the at least one specific instruction 220 based on the identified modification in the second set of dependency files 218B.

By way of example, and not by limitation, the system 202 generates the at least one specific instruction as “RUN pip install -upgrade numpy==1.25.0 flask==2.2.0 && pip install scikit-learn 1.3.1 && pip remove pandas” since the identified modification was that the package version of flask needed to be downgraded from 2.3.2 to 2.2.0 and the package version of numpy needed to be upgraded from 1.24.2 to 1.25.0, a new dependency file “scikit-learn 1.3.1” needs to be installed, a dependency file “pandas 1.5.3” can be uninstalled, and rest of the dependency files are the same.

At 318, a dependency file modification operation is performed. In the dependency file modification operation, the system 202 is configured to modify the at least one dependency file of the second set of dependency files based on the generated at least one specific instruction 220. In an embodiment, the system 202 is configured to execute the generated at least one specific instruction and then modify the at least one dependency file based on the execution of the generated at least one specific instruction 220. As discussed above, the modification may correspond to an upgrade or a downgrade of the package version of the at least one dependency file, an addition of a specific dependency file (indicated by a new package name in the first set of dependency files), a deletion of a specific dependency file (indicated when a package name is missing in the first set of dependency files), or a modification in the environment variable associated with the at least one dependency file. By way of example, the system 202 installs a new dependency file “scikit-learn 1.3.1”, upgrades the numpy package version from 1.24.2 to 1.25.0, downgrades the flask package version from 2.3.2 to 2.2.0, and uninstalls the pandas dependency file based on the execution of the generated at least one specific instruction “RUN pip install -upgrade numpy==1.25.0 flask==2.2.0 && pip install scikit-learn 1.3.1 && pip remove pandas”.

At 320, a specific portion generation operation is performed. In the specific portion generation operation, the system 202 is configured to generate the specific portion 222A (the fixpack layer 222A) of the specific layer 216A based on the generated at least one specific instruction 220 and the at least one modified dependency file. The system 202 may be configured to execute the generated at least one specific instruction 220 and then generate the fixpack layer 222A based on the execution of the generated at least one specific instruction 220. The cache data associated with the fixpack layer 222A may include the at least one modified dependency file and the generated at least one specific instruction 220. Instead of regenerating the entire specific layer 216A of the container image 216, the system 202 is configured to generate only the specific portion 222A (the fixpack layer 222A) of the specific layer 216A. The bit size of the generated specific portion 222A (the fixpack layer 222A) is less than the bit size of the specific layer since only the at least one modified dependency file needs to be added to the cache data associated with the generated specific portion 222A. The execution time for the generation of the specific portion 222A (the fixpack layer 222A) is less than the execution time for the regeneration of the specific layer since the system 202 needs to execute only the at least one specific instruction 220 and not the entire first set of instructions 214A, and also the bit size of the generated specific portion is less than the bit size of the specific layer 216A. Since the execution time for the generation of the specific portion 222A (the fixpack layer 222A) is less than the execution time for the regeneration of the specific layer, which in turn reduces the overall processing time for the generation of the modified container image 222. By way of example, and not by limitation, the system 202 generates the fixpack layer 222A based on the generated at least one instruction “RUN pip install -upgrade numpy==1.25.0 flask==2.2.0 && pip install scikit-learn 1.3.1 && pip remove pandas” and the at least one modified dependency file “scikit-learn 1.3.1, numpy 1.25.0, and flask 2.2.0”.

FIG. 3B is a diagram that illustrates exemplary operations for the generation of a modified container image using cache data, in accordance with an embodiment of the disclosure. FIG. 3B is explained in conjunction with elements from FIG. 1, FIG. 2, and FIG. 3A. With reference to FIG. 3B, there is shown the block diagram 300B that illustrates exemplary operations from 322 to 330, as described herein. With reference to FIG. 3B, there is further shown the generated modified container image 222. The exemplary operations illustrated in the block diagram 300B start at 322 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300B can be divided into additional blocks, combined into fewer blocks, or eliminated, depending on the implementation.

At 322, a specific portion embedding operation is performed. In the specific portion embedding operation, the system 202 is configured to embed the generated specific portion 222A (the fixpack layer 222A) into the set of layers of the original container image 216. In an embodiment, the system 202 is configured to embed the generated specific portion 222A (the fixpack layer 222A) into the specific layer 216A to generate a new layer that stores the at least one modified dependency file. The system 202 further replaces the specific layer 216A with the generated new layer in the original container image 216. In an embodiment, the system 202 embeds the generated specific portion 222A in order to implement the intended functionality of the at least one modified dependency file in the container image 216 and to ensure the smooth functioning of the application. By way of example, and not by limitation, the system 202 embeds the fixpack layer 222A to the specific layer 216A to generate a new layer and replace the specific layer 216A with the new layer to implement the functionality of the at least one modified dependency file “scikit-learn 1.3.1, numpy 1.25.0, and flask 2.2.0”.

At 324, a cache data modification operation is performed. In the cache data modification operation, the system 202 is configured to modify the cache data 218 based on the embedded specific portion 222A. In an embodiment, the system 202 is configured to add the at least one modified dependency file into the cache data 218 associated with the new layer. In an embodiment, the system 202 is further configured to replace the second set of instructions 218A with the first set of instructions 214A in the cache data 218 associated with the generated new layer. In an embodiment, the system 202 is further configured to store the modified cache data 218. By way of example, and not by limitation, the system 202 adds the at least one modified dependency file “scikit-learn 1.3.1, numpy 1.25.0, and flask 2.2.0” into the cache data 218, and stores the modified cache data 218.

At 326, a metadata modification operation is performed. In the metadata modification operation, the system 202 is configured to modify metadata associated with the specific layer 216A of the container image 216, based on the generated specific portion 222A (the fixpack layer 222A). In an embodiment, the metadata includes a set of layer identifiers associated with each layer of the set of layers, which uniquely identifies the corresponding layer within the container image 216 and stores the data associated with the dependency files associated with the corresponding layer. In an embodiment, the metadata associated with the specific layer 216A includes a specific layer identifier (a hash value) associated with the specific layer 216A that needs to be modified since the specific layer has been replaced with the new layer generated by embedding the fixpack layer 222A into the specific layer 216A.

In an embodiment, for the modification of the metadata, the system 202 is configured to generate a layer identifier (a hash value) associated with the generated specific portion 222A based on the generated at least one specific instruction 220. The layer identifier (hash value) is a fixed-size string of characters generated by hash functions that may uniquely represent the contents of code (such as the at least one modified dependency file). The hash functions are mathematical algorithms that transform input data (such as at least one modified dependency file) into a fixed-size string of characters. Various types of hash functions are, but not limited to, Message Digest Algorithm 5 (MD5), Secure Hash Algorithm 1 (SHA-1), and Secure Hash Algorithm 2 (SHA-2).

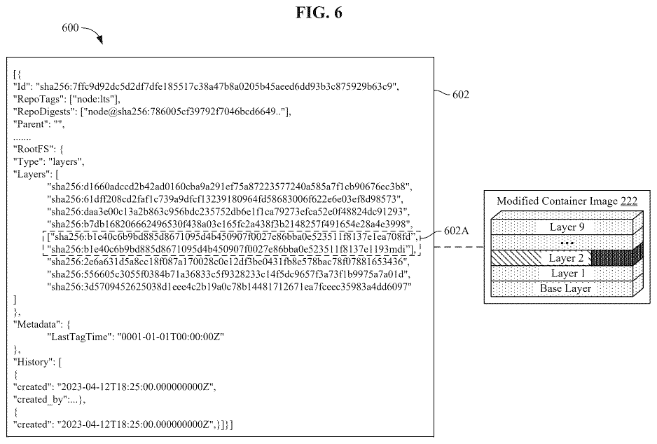

In an embodiment, the system 202 is further configured to modify the metadata associated with the specific layer 216A based on the generated layer identifier. In an embodiment, the system 202 is configured to add the layer identifier associated with the generated specific portion 222A into the specific identifier associated with the specific layer 216A to generate a new layer identifier, which uniquely identifies the new layer within the container image 216. The new layer identifier may be added in the form of a vector or an array of two hash values since the new layer identifier identifies two portions (e.g. the specific layer 216A and the fixpack layer 222A). By way of example, and not by limitation, in case the specific identifier associated with the specific layer is “sha256:b1e40c6b9bd885d8671095d4b450907f0027e86bba0e523511f8137e1ea708fd”, the system 202 firstly generates the layer identifier associated with the fixpack layer 222A as “sha256:ble40c6b9bd885d8671095d4b450907f0027e86bba0e523511f8137e1193mdi” and then adds it to the specific identifier to generate the new layer identifier in the form of the vector or an array as [“sha256:b1e40c6b9bd885d8671095d4b450907f0027e86bba0e523511f8137e1ea708fd”, “sha256:b1e40c6b9bd885d8671095d4b450907f0027e86bba0e523511f8137e1193mdi”]. In an embodiment, the system 202 is further configured to store the modified metadata. A pictorial representation of the modified metadata is provided, for example, in FIG. 6.

At 328, a modified container image generation operation is performed. In the modified container image generation operation, the system 202 is configured to generate the modified container image 222 of the application, based on the modification of the cache data and the modification of the metadata. In an embodiment, the modified container image 222 includes the embedded specific portion 222A and the set of layers of the original container image 216. The modified container image 222 is further associated with the modified cache data and the modified metadata. Instead of regenerating the entire specific layer, the system 202 generates only the specific portion 222A and the execution time for the generation of the specific portion 222A (the fixpack layer 222A) is less than the execution time for the regeneration of the specific layer, hence the system 202 reduces the overall processing time for the generation of the modified container image 222.

At 330, a modified container image output operation is performed. In the modified container image output operation, the system 202 is configured to output the generated modified container image 222. In an embodiment, the system 202 is configured to store the generated modified container image 222 in the repository 208. In an alternate embodiment, the system 202 is configured to render the message associated with the generation of the modified container image 222 on the user device 204. In an alternate embodiment, the system 202 may be further configured to initialize the container to run the generated modified container image 222. Details about the initialization of the container are further provided, for example, in FIG. 4.

FIG. 4 is a diagram that illustrates exemplary operations for the deployment of a container to host the application using the modified container image, in accordance with an embodiment of the disclosure. With reference to FIG. 4, there is shown the block diagram 400 that illustrates exemplary operations from 402 to 404, as described herein. With reference to FIG. 4, there is further shown the generated modified container image 222, a retrieved modified container image 402A, and a container 404A. The exemplary operations illustrated in the block diagram 400 start at 402 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400 can be divided into additional blocks, combined into fewer blocks, or eliminated, depending on the implementation.

At 402, a modified container image retrieval operation is performed. In the modified container image retrieval operation, the system 202 is configured to obtain the stored modified container image 222 from the repository, based on the modified metadata. As discussed above, the modified metadata includes the generated layer identifier added into the set of layer identifiers (specifically into the specific identifier associated with the specific layer) in the form of the vector or the array. In an embodiment, the system 202 is configured to obtain the stored modified container image, layer-by layer, by parsing the modified metadata. In an embodiment, the system 202 parses each identifier of the set of identifiers in the modified metadata and obtains the corresponding layer from the repository. For the specific layer 216A and the fixpack layer 222A, as discussed above, the generated layer identifier is added to the specific identifier in the form of the vector or the array. Hence, the system 202 identifies the two layers as individual layers, pulls the specific layer 216A first, and then pulls and places the fixpack layer 222A on the top of the specific layer 216A to obtain the retrieved container image 402A. The retrieved container image 402A includes the set of layers of the modified container image 222 with the fixpack layer 222A placed on top of the specific layer 216A. A pictorial representation of the modified metadata (that includes the generated layer identifier added into the specific identifier as a vector) is provided further, for example, in FIG. 6.

At 404, a container deployment operation is performed. In the container deployment operation, the system 202 is configured to control a deployment of the container 404A. The deployment of the container is controlled based on the retrieved modified container image 402A. In an embodiment, the system 202 configures the container 404A to run the retrieved modified container image 402A of the application. The container 404A includes the resources, dependencies, and environment that are vital for the application to run. In an embodiment, the system 202 is configured to generate and add a container layer on top of the set of layers of the retrieved modified container image 402A. Unlike the set of layers that are read-only, the container layer is a writable layer that sits on top of the set of layers, and the container layer allows the system 202 to make any runtime changes in case the runtime changes are needed.

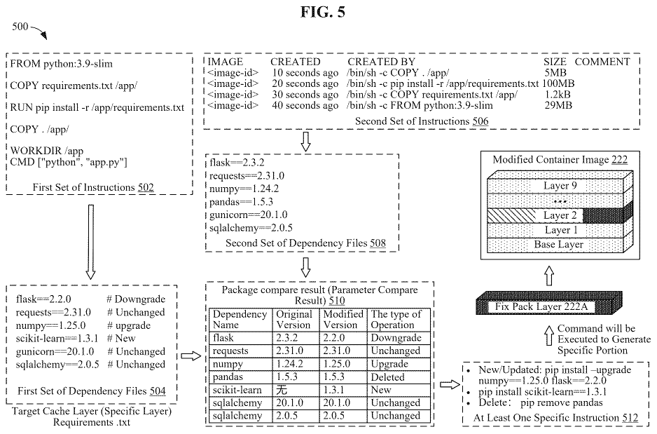

FIG. 5 is a diagram that illustrates an exemplary pictorial representation of a scenario for the generation of a modified container image using cache data, in accordance with an embodiment of the disclosure. With reference to FIG. 5, there is shown a pictorial representation 500 that includes a first set of instructions 502 associated with a first set of dependency files 504. With reference to FIG. 5, the pictorial representation 500 further includes a second set of instructions 506 that is associated with a second set of dependency files 508. With reference to FIG. 5, the pictorial representation 500 further includes a package compare result 510 (may also be referred to as a parameter compare result), at least one specific instruction 512. With reference to FIG. 5, the pictorial representation 500 further includes the generated fixpack layer 222A and the generated modified container image 222. The first set of instructions 502, the first set of dependency files 504, the second set of instructions 506, the second set of dependency files 508, and the at least one specific instruction 512 are exemplary embodiments of the first set of instructions 214A, the first set of dependency files 214B, the second set of instructions 218A, the second set of dependency files 218B, and the at least one specific instruction 220, respectively.

As discussed above, in the description of FIG. 3A and FIG. 3B, and as illustrated in FIG. 5, the system 202 is configured to receive the first set of instructions 502 for the regeneration of the specific layer 216A (a target cache layer). The first set of instructions 502 includes the first directory path that is associated with the first set of dependency files 504. By way of example, and not by limitation, the first set of dependency files 504 include “flask==2.2.0”, “requests==2.31.0”, “numpy==1.25.0”, “scikit-learn==1.3.1”, “gunicorn==20.1.0”, “sqlalchemy==2.0.5”. Details about the reception of the first set of instructions are provided, for example, in FIG. 2 and FIG. 3A.

The system 202 is further configured to obtain the second set of instructions 506 that were used during the historical build of the specific layer 216A from the cache data 218. The second set of instructions 506 further includes the second directory path associated with the second set of dependency files 508. By way of example, and not by limitation, the second set of dependency files 508 include “flask==2.3.2”, “requests==2.31.0”, “numpy==1.24.2”, “pandas==1.5.3”, “gunicorn==20.1.0”, and “sqlalchemy==2.0.5”. Details about the second set of instructions retrieval are provided, for example, in FIG. 2 and FIG. 3A.

The system 202 is further configured to compare the first parameter associated with each dependency file of the first set of dependency files 504 with the second parameter associated with the corresponding dependency file of the second set of dependency files 508. Based on the comparison, the system 202 is configured to identify the modification that is needed in the second set of dependency files 508 and then generate the package compare result 510. The package compare result 510 is a table that indicates the modification that is needed for the corresponding dependency file of the second set of dependency files 508. Details about the parameters comparison and file comparison are provided, for example, in FIG. 2 and FIG. 3A. By way of example and not by limitation, based on the comparison of the first parameter associated with each dependency file of the first set of dependency files 504 with the second parameter associated with the corresponding dependency file of the second set of dependency files 508, the system 202 determines that the package “flask” needs to be downgraded from “23.2” to “2.2.0”, package “numpy” needs to be upgraded from “1.24.2” to “1.25.0”, package “scikit-learn 1.3.1” needs to be installed, and package “pandas 1.5.3” can be uninstalled. The package compare result 510 can be represented in Table 3 below:

TABLE 3
Package Compare Result

| | Original | Modified | The type of operation |
|---|---|---|---|
| Dependency name | version | version | (Modification) |
| flask | 2.3.2 | 2.2.0 | Downgrade |
| requests | 2.31.0 | 2.31.0 | Unchanged |
| numpy | 1.24.2 | 1.25.0 | Upgrade |
| pandas | 1.5.3 | 1.5.3 | Deleted |
| scikit-learn | | 1.3.1 | New |
| gunicorn | 20.1.0 | 20.1.0 | Unchanged |
| sqlalchemy | 2.0.5 | 2.0.5 | Unchanged |

Based on the modification that is needed in the second set of dependency files 508, the system 202 is configured to generate the at least one specific instruction 512. By way of example, and not by limitation, since the system 202 determined that the package “flask” needs to be downgraded from “2.3.2” to “2.2.0”, package “numpy” needs to be upgraded from “1.24.2” to “1.25.0”, package “scikit-learn 1.3.1” needs to be installed, and package “pandas 1.5.3” can be uninstalled, hence the system 202 generates the at least one specific instruction 512 as “RUN pip install -upgrade numpy==1.25.0 flask==2.2.0 && pip install scikit-learn 1.3.1 && pip remove pandas”. Details about the generation of the at least one specific instruction are provided, for example, in FIG. 2 and FIG. 3A.

Further, the system 202 is configured to generate the specific portion 222A (the fixpack layer 222A) of the specific layer 216A based on the generated at least one specific instruction 512. The system 202 is further configured to generate the modified container image 222 based on the generated specific portion 222A. Details about the generation of the specific portion and the modified container image are provided, for example, in FIG. 2, FIG. 3A, and FIG. 3B.

FIG. 6 is a diagram that illustrates an exemplary pictorial representation of the modified metadata associated with the generated modified container image, in accordance with an embodiment of the disclosure. With reference to FIG. 6, there is shown a pictorial representation 600, which includes the modified container image 222, a manifest file 602 of the modified container image 222, and a vector 602A that includes the identifier associated with the new layer generated by embedding the specific portion 222A (the fixpack layer 222A) into the specific layer 216A.

As discussed above, in the description of FIG. 3B, and illustrated in FIG. 6, the manifest file 602 of the modified container image 222 includes the modified metadata associated with the set of layers of the modified container image 222. The modified metadata includes the set of identifiers associated with the set of layers and the generated layer identifier. Unlike the new layer that has been generated by the system 202 after embedding the specific portion 222A into the specific layer 216A, each layer of the set of layers is uniquely identified by the corresponding identifier (hash value) of the set of identifiers. However, since the new layer is generated by embedding the fixpack layer 222A into the specific layer 216A, the new layer is uniquely identified by the vector 602A or the array containing two different identifiers. The first identifier (hash value) in the vector 602A is for the original specific layer 216A and the second identifier in the vector 602A uniquely identifies the fixpack layer 222A. Details about the modification of metadata are provided, for example, in FIG. 3B.

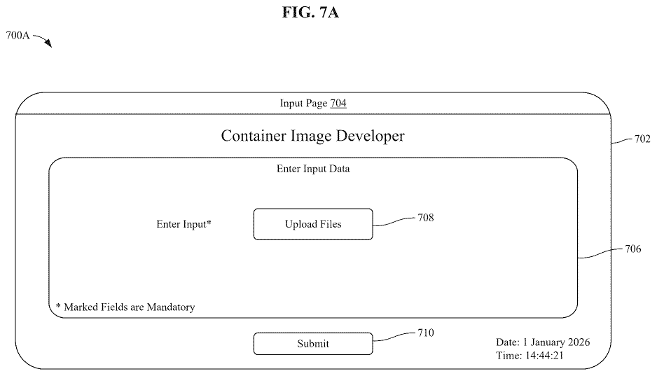

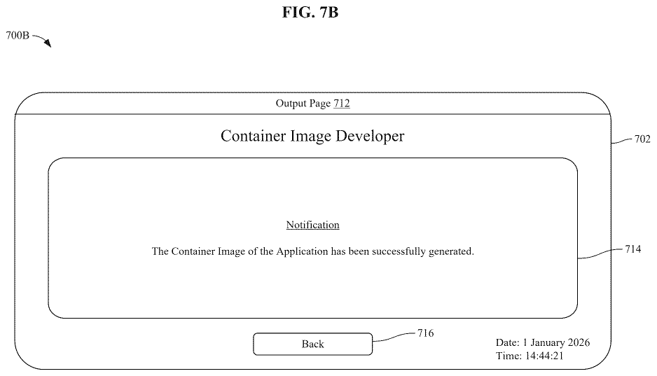

FIG. 7A is a diagram that illustrates an exemplary first user interface for modification of container images using cache data, in accordance with an embodiment of the disclosure. FIG. 7A is explained in conjunction with elements from FIG. 1, FIG. 2, FIG. 3A, FIG. 3B, FIG. 4, FIG. 5, and FIG. 6. With reference to FIG. 7A, there is shown an exemplary diagram 700A that includes a user device 702 and an input page 704. The input page 704 includes a first user interface (UI) element 706, a second UI element 708, and a third UI element 710. The user device 702 is an exemplary embodiment of the user device 204 of FIG. 2.

With reference to FIG. 7A, the computer system 202 renders the input page 704 on the user interface (UI) of the user device 702. The input page 704 corresponds to a web page or online form that is designed to collect information from the user 224. In an embodiment of the disclosure, the input page 704 is used to gather relevant details from the user for the generation of the modified container image 222 of the application.

As discussed above, the computer system 202 obtains the first set of instructions 214A and specific instructions for the regeneration of the specific layer 216A and the generation of the set of layers of the modified container image 222 of the application. The first UI element 706 corresponds to a textbox and is labeled as “Enter input data”. The computer system 202 obtains the first set of instructions 214A and the specific instructions via the first UI element 706.

The second UI element 708 corresponds to a button labeled “Upload files”. Upon selecting the second UI element 708, the computer system 202 obtains the first set of instructions 214A and specific instructions from the user device 702. The second UI element 708 is a mandatory input parameter for the generation of the modified container image 222 of the application. The third UI element 710 corresponds to a button and is labeled as “Submit”. Upon selecting the third UI element 710, the computer system 202 receives the information and generates the modified container image 222 of the application. Details about the generation of the modified container image operation are provided, for example, in FIG. 2 and FIG. 3A.

FIG. 7B is a diagram that illustrates an exemplary second user interface for modification of container images using cache data, in accordance with an embodiment of the disclosure. FIG. 7B is explained in conjunction with elements from FIG. 1, FIG. 2, FIG. 3A, FIG. 3B, FIG. 4, FIG. 5, FIG. 6, and FIG. 7A. With reference to FIG. 7B, there is shown an exemplary diagram 700B that includes the user device 702 and an output page 712. The output page 712 includes a fourth UI element 714 and a fifth UI element 716. The user device 702 is an exemplary embodiment of the user device 204 of FIG. 2.

With reference to FIG. 7B, the computer system 202 renders the output page 712 on the display unit (or the user interface) of the user device 702 based on the generation of the modified container image 222 of the application. The computer system 202 renders the message on the output page 712 that indicates that the modified container image of the application is generated.

The fourth UI element 714 corresponds to a textbox that includes the message that indicates that the modified container image 222 is generated. By way of example, and not by limitation, the computer system 202 renders the message “Notification: The Container Image of the Application has been successfully generated”. The fifth UI element 716 corresponds to a button and is labeled as “Back”. Upon selecting the fifth UI element 716, the computer system 202 renders the input page 704 on the user device 702.

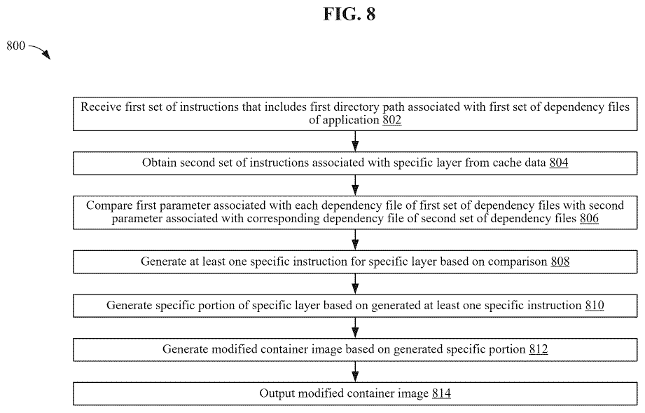

FIG. 8 is a diagram that illustrates a flowchart of an exemplary method for the generation of a modified container image using cache data, in accordance with an embodiment of the disclosure. FIG. 8 is explained in conjunction with elements from FIG. 1, FIG. 2, FIG. 3A, FIG. 3B, FIG. 4, FIG. 5, FIG. 6, FIG. 7A, and FIG. 7B. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the first set of instructions 502 that includes the first directory path associated with the first set of dependency files 504 of the application is received. The first set of instructions 502 is associated with the regeneration of the specific layer 216A. In an embodiment, the system 202 is configured to receive the first set of instructions 502 that includes the first directory path associated with the first set of dependency files 504 of the application. The first set of instructions 502 is associated with the regeneration of the specific layer 216A. Details about the first set of instructions retrieval operation are provided, for example, in FIG. 2 and FIG. 3A.

At 804, the second set of instructions 506 associated with the specific layer 216A is obtained from the cache data 218. The second set of instructions 506 further includes the second directory path associated with the second set of dependency files 508. In an embodiment, the system 202 is configured to obtain the second set of instructions 506 associated with the specific layer 216A, from the cache data 218. The second set of instructions 506 further includes the second directory path associated with the second set of dependency files 508. Details about the second set of instructions retrieval operation are provided, for example, in FIG. 2 and FIG. 3A.

At 806, the first parameter associated with each dependency file of the first set of dependency files 504 is compared with the second parameter associated with the corresponding dependency file of the second set of dependency files 508. In an embodiment, the system 202 is configured to compare the first parameter associated with each dependency file of the first set of dependency files 504 with the second parameter associated with the corresponding dependency file of the second set of dependency files 508. Details about the parameters comparison and file comparison are provided, for example, in FIG. 2 and FIG. 3A.

At 808, the at least one specific instruction 512 is generated based on the comparison. The generated at least one specific instruction 512 is indicative of the modification of at least one dependency file of the second set of dependency files 508. In an embodiment, the system 202 is configured to generate the at least one specific instruction 512 based on the comparison. The generated at least one specific instruction 512 is indicative of the modification of at least one dependency file of the second set of dependency files 508. Details about the generation of the at least one specific instruction are provided, for example, in FIG. 2 and FIG. 3A.

At 810, the specific portion 222A (the fixpack layer 222A) of the specific layer 216A is generated based on the generated at least one specific instruction 512. The bit size of the generated specific portion 222A is less than the bit size of the specific layer 216A. The execution time for generating the specific portion 222A is less than the execution time for the regeneration of the specific layer 216A. In an embodiment, the system 202 is configured to generate the specific portion 222A (the fixpack layer 222A) of the specific layer 216A based on the generated at least one specific instruction 512. The bit size of the generated specific portion 222A is less than the bit size of the specific layer 216A. The execution time for generating the specific portion 222A is less than the execution time for the regeneration of the specific layer 216A. Details about the generation of the specific portion are provided for example, in FIG. 2 and FIG. 3A.

At 812, the modified container image 222 of the application is generated based on the generated specific portion 222A. In an embodiment, the system 202 is configured to generate the modified container image 222 of the application based on the generated specific portion 222A. Details about the generation of the modified container image 222 are provided for example, in FIG. 2 and FIG. 3B.

At 814, modified container image 222 is outputted. In an embodiment, the system 202 is configured to output the modified container image 222. Details about the modified container image 222 output operation are provided for example, in FIG. 2 and FIG. 3B.

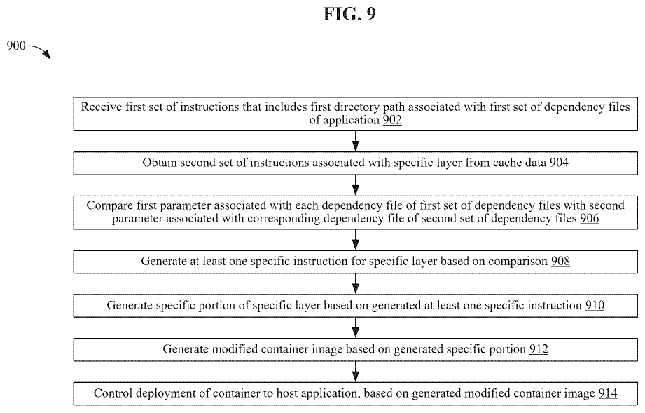

FIG. 9 is a diagram that illustrates a flowchart of an exemplary method for the deployment of a container to host an application using the modified container image, in accordance with an embodiment of the disclosure. FIG. 9 is explained in conjunction with elements from FIG. 1, FIG. 2, FIG. 3A, FIG. 3B, FIG. 4, FIG. 5, FIG. 6, FIG. 7A, FIG. 7B, and FIG. 8. With reference to FIG. 9, there is shown a flowchart 900. The operations of the exemplary method may be executed by any computing system, for example, by the computer 102 of FIG. 1 or the computer system 202 of FIG. 2. The operations of the flowchart 900 may start at 902.

At 902, the first set of instructions 502 that includes the first directory path associated with the first set of dependency files 504 of the application is received. The first set of instructions 502 is associated with the regeneration of the specific layer 216A. In an embodiment, the system 202 is configured to receive the first set of instructions 502 that includes the first directory path associated with the first set of dependency files 504 of the application. The first set of instructions 502 is associated with the regeneration of the specific layer 216A. Details about the first set of instructions retrieval operation are provided, for example, in FIG. 2 and FIG. 3A.

At 904, the second set of instructions 506 associated with the specific layer 216A is obtained from the cache data 218. The second set of instructions 506 further includes the second directory path associated with the second set of dependency files 508. In an embodiment, the system 202 is configured to obtain the second set of instructions 506 associated with the specific layer 216A from the cache data 218. The second set of instructions 506 further includes the second directory path associated with the second set of dependency files 508. Details about the second set of instructions retrieval operation are provided, for example, in FIG. 2 and FIG. 3A.

At 906, the first parameter associated with each dependency file of the first set of dependency files 504 is compared with the second parameter associated with the corresponding dependency file of the second set of dependency files 508. In an embodiment, the system 202 is configured to compare the first parameter associated with each dependency file of the first set of dependency files 504 with the second parameter associated with the corresponding dependency file of the second set of dependency files 508. Details about the parameters comparison and file comparison are provided, for example, in FIG. 2 and FIG. 3A.

At 908, the at least one specific instruction 512 is generated based on the comparison. The generated at least one specific instruction 512 is indicative of the modification of at least one dependency file of the second set of dependency files 508. In an embodiment, the system 202 is configured to generate the at least one specific instruction 512 based on the comparison. The generated at least one specific instruction 512 is indicative of the modification of at least one dependency file of the second set of dependency files 508. Details about the generation of the at least one specific instruction is provided, for example, in FIG. 2 and FIG. 3A.

At 910, the specific portion 222A (the fixpack layer 222A) of the specific layer 216A is generated based on the generated at least one specific instruction 512. The bit size of the generated specific portion 222A is less than the bit size of the specific layer 216A. The execution time for generating the specific portion 222A is less than the execution time for the regeneration of the specific layer 216A. In an embodiment, the system 202 is configured to generate the specific portion 222A (the fixpack layer 222A) of the specific layer 216A based on the generated at least one specific instruction 512. The bit size of the generated specific portion 222A is less than the bit size of the specific layer 216A. The execution time for generating the specific portion 222A is less than the execution time for the regeneration of the specific layer 216A. Details about the generation of the specific portion are provided for example, in FIG. 2 and FIG. 3A.

At 912, the modified container image 222 of the application is generated based on the generated specific portion 222A. In an embodiment, the system 202 is configured to generate the modified container image 222 of the application based on the generated specific portion 222A. Details about the generation of the modified container image 222 are provided for example, in FIG. 2 and FIG. 3B.

At 914, the deployment of the container 404A, is controlled to host the application. The deployment of the container 404A is controlled based on the generated modified container image 222. In an embodiment, the system 202 is configured to control the deployment of the container 404A to host the application. The deployment of the container 404A is controlled based on the generated modified container image 222. Details about the container deployment operation are provided for example, in FIG. 4.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, a first set of instructions comprising a first directory path associated with a first set of dependency files of an application, wherein:
the first set of instructions is associated with a regeneration of a specific layer of a container image,
the container image is associated with the application, and
the regeneration of the specific layer is based on the first set of dependency files;
obtaining, by the computer, a second set of instructions associated with the specific layer, wherein:
the second set of instructions comprises a second directory path associated with a second set of dependency files of the application,
the second set of instructions is obtained from cache data, and
the cache data is associated with the container image;
comparing, by the computer, a first parameter associated with each dependency file of the first set of dependency files with a second parameter associated with a corresponding dependency file of the second set of dependency files;
generating, by the computer, at least one specific instruction for the specific layer based on the comparing of the first parameter with the second parameter, wherein the at least one specific instruction is indicative of a modification of at least one dependency file of the second set of dependency files;
generating, by the computer, a specific portion of the specific layer based on the generated at least one specific instruction;
generating, by the computer, a modified container image of the application based on the generated specific portion; and
outputting, by the computer, the modified container image.

2. The computer-implemented method of claim 1, further comprising:
embedding, by the computer, the generated specific portion to a set of layers associated with the container image, wherein the set of layers comprises the specific layer;
generating, by the computer, the modified container image based on the set of layers and the embedded specific portion; and
storing, by the computer, the generated modified container image.

3. The computer-implemented method of claim 2, further comprising:
generating, by the computer, a layer identifier associated with the generated specific portion based on the generated at least one specific instruction;
modifying, by the computer, metadata associated with the set of layers by adding the generated layer identifier into a set of identifiers, wherein the modified metadata comprises the set of identifiers and the generated layer identifier, and wherein the set of identifiers is associated with the set of layers; and
storing, by the computer, the modified metadata.

4. The computer-implemented method of claim 3, further comprising:
obtaining, by the computer, the stored modified container image based on the modified metadata; and
controlling, by the computer, a deployment of a container to host the application, wherein the controlling of the deployment of the container is based on the obtained modified container image.

5. The computer-implemented method of claim 1, wherein the modification of the at least one dependency file corresponds to the modification of at least one parameter associated with the at least one dependency file, and wherein the at least one parameter corresponds to at least one of a package version associated with the at least one dependency file, a package name associated with the at least one dependency file, or an environment variable associated with the at least one dependency file.

6. The computer-implemented method of claim 1, further comprising:
modifying, by the computer, the second set of instructions based on the first set of instructions, wherein the modification of the second set of instructions corresponds to a replacement of the second set of instructions with the first set of instructions, and wherein the cache data comprises the second set of instructions;
modifying, by the computer, the cache data based on the modified second set of instructions; and
storing, by the computer, the modified cache data.

7. The computer-implemented method of claim 1, further comprising:
executing, by the computer, the generated at least one specific instruction;
modifying, by the computer, the at least one dependency file based on the execution of the at least one specific instruction; and
generating, by the computer, the specific portion based on the at least one modified dependency file.

8. The computer-implemented method of claim 7, further comprising:
modifying, by the computer, the cache data by adding the at least one modified dependency file to the cache data; and
storing, by the computer, the modified cache data.

9. The computer-implemented method of claim 1, further comprising:
obtaining, by the computer, the first set of dependency files associated with the first directory path, and the second set of dependency files associated with the second directory path;
parsing, by the computer, the obtained first set of dependency files and the obtained second set of dependency files; and
determining, by the computer, the first parameter and the second parameter, based on the parsed first set of dependency files and the parsed second set of dependency files, respectively, wherein the determining of the first parameter and the second parameter is prior to the comparing of the first parameter with the second parameter.

10. The computer-implemented method of claim 1, further comprising:
comparing, by the computer, the first set of instructions with the second set of instructions;
determining, by the computer, each instruction of the first set of instructions is identical to a corresponding instruction of the second set of instructions, based on the comparison of the first set of instructions with the second set of instructions;
comparing, by the computer, the first parameter associated with each dependency file of the first set of dependency files with the second parameter associated with the corresponding dependency file of the second set of dependency files, based on the determination that each instruction of the first set of instructions is identical to the corresponding instruction of the second set of instructions; and
generating, by the computer, the at least one specific instruction for the specific layer, based on the comparison of the first parameter with the second parameter, and the determination that each instruction of the first set of instructions is identical to the corresponding instruction of the second set of instructions.

11. The computer-implemented method of claim 1, wherein the first parameter corresponds to one of a package version associated with each dependency file of the first set of dependency files, a package name associated with each dependency file of the first set of dependency files, or an environment variable associated with each dependency file of the first set of dependency files.

12. The computer-implemented method of claim 1, wherein the second parameter corresponds to one of a package version associated with each dependency file of the second set of dependency files, a package name associated with each dependency file of the second set of dependency files, or an environment variable associated with each dependency file of the second set of dependency files.

13. The computer-implemented method of claim 1, wherein a bit size of the generated specific portion is less than a bit size of the specific layer, and wherein an execution time for the generating of the specific portion is less than an execution time for the regeneration of the specific layer.

14. A computer system, comprising:
a processor set;
one or more computer-readable storage media; and
program instructions stored on the one or more computer-readable storage media, the program instructions executable by the processor set to cause the processor set to:
receive a first set of instructions that comprises a first directory path associated with a first set of dependency files of an application, wherein:
the first set of instructions is associated with a regeneration of a specific layer of a container image,
the container image is associated with the application, and
the regeneration of the specific layer is based on the first set of dependency files;
obtain a second set of instructions associated with the specific layer, wherein:
the second set of instructions comprises a second directory path associated with a second set of dependency files of the application,
the second set of instructions is obtained from cache data, and
the cache data is associated with the container image;
compare a first parameter associated with each dependency file of the first set of dependency files with a second parameter associated with a corresponding dependency file of the second set of dependency files;
generate at least one specific instruction for the specific layer based on the comparison of the first parameter with the second parameter, wherein the at least one specific instruction is indicative of a modification of at least one dependency file of the second set of dependency files;
generate a specific portion of the specific layer based on the generated at least one specific instruction;
generate a modified container image of the application based on the generated specific portion; and
control a deployment of a container to host the application, wherein the control of the deployment of the container is based on the generated modified container image.

15. The computer system of claim 14, wherein the program instructions further cause the processor set to:
embed the generated specific portion to a set of layers associated with the container image, wherein the set of layers comprises the specific layer;
generate the modified container image, based on the set of layers and the embedded generated specific portion; and
store the modified container image.

16. The computer system of claim 15, wherein the program instructions further cause the processor set to:
generate a layer identifier associated with the generated specific portion based on the generated at least one specific instruction;
modify metadata associated with the set of layers based on an addition of the generated layer identifier into a set of identifiers, wherein the modified metadata comprises the set of identifiers and the generated layer identifier, and wherein the set of identifiers is associated with the set of layers; and
store the modified metadata.

17. The computer system of claim 16, wherein the program instructions further cause the processor set to:
obtain the stored modified container image based on the modified metadata; and
control the deployment of the container to host the application, wherein the control of the deployment of the container is based on the obtained modified container image.

18. The computer system of claim 14, wherein a bit size of the generated specific portion is less than a bit size of the specific layer, and wherein an execution time for the generation of the specific portion is less than an execution time for the regeneration of the specific layer.

19. A computer-program product for modification of a specific layer of a container image, the computer-program product comprising:
one or more computer-readable storage media; and
program instructions stored on the one or more computer-readable storage media to perform operations comprising:
receiving a first set of instructions that comprises a first directory path associated with a first set of dependency files of an application, wherein:
the first set of instructions is associated with a regeneration of the specific layer of the container image,
the container image is associated with the application, and
the regeneration of the specific layer is based on the first set of dependency files;
obtaining a second set of instructions associated with the specific layer, wherein:
the second set of instructions comprises a second directory path associated with a second set of dependency files of the application,
the second set of instructions is obtained from cache data, and
the cache data is associated with the container image;
comparing a first parameter associated with each dependency file of the first set of dependency files with a second parameter associated with a corresponding dependency file of the second set of dependency files;
generating at least one specific instruction for the specific layer based on the comparing of the first parameter with the second parameter, wherein the at least one specific instruction is indicative of a modification of at least one dependency file of the second set of dependency files;
generating a specific portion of the specific layer based on the generated at least one specific instruction;
generating a modified container image of the application based on the generated specific portion; and
outputting the modified container image.

20. The computer-program product of claim 19, wherein a bit size of the generated specific portion is less than a bit size of the specific layer, and wherein an execution time for the generating of the specific portion is less than an execution time for the regeneration of the specific layer.
